(19) United States
(12) Patent Application Publication
(10) Pub. No.: US 2002/0019880 A1
(43) Pub. Date: Feb. 14, 2002

(54) IP communication system for wireless terminal and communication method for wireless terminal

(76) Inventor: Takashi Sakakura, Tokyo (JP)

Correspondence Address: BIRCH STEWART KOLASCH & BIRCH, PO BOX 747, FALLS CHURCH, VA, 22040-0747, US

(21) Appl. No.: 09/895,156

(22) Filed: Jul. 2, 2001

(30) Foreign Application Priority Data
Jul. 3, 2000 (JP) 2000-200529
Sep. 28, 2000 (JP) 2000-295971
Oct. 12, 2000 (JP) 2000-311774

(51) Int. Cl. G06F 15/16

(52) U.S. Cl. 709/245; 709/224

(57) ABSTRACT

An IP communication system for wireless terminal which eliminates extra traffic to be used for data transfer so as to improve communication latency. The IP communication system for wireless terminal includes a control center, which controls a plurality of wireless terminals by way of a base station for communicating with an internet terminal over the Internet. The control center controls a plurality of IP addresses. The control center is provided with a database for storing the MAC addresses of wireless terminals controlled, the operating status of the respective wireless terminals controlled, and the identification of the respective base stations. The control center allocates one of the IP addresses available to a wireless terminal in the database in response to a request for communication between the wireless terminal and the internet terminal. The wireless terminal communicates with the internet terminal based on this IP address allocated.

### BACKGROUND OF THE INVENTION

1. Field of the Invention

The present invention relates generally to a method for connecting an IP (internet protocol) packet network with a mobile communication network. Particularly, the present invention relates to a communication method for an effective use of communication traffic. More specifically, the present invention relates substantially to a dynamic allocation of an IP address to a wireless terminal in an IP communication system for wireless terminal.

In addition to that, the present invention also relates to a wireless communication method which is applicable to a system in which a plurality of wireless terminals can effectively access a shared wireless channel. More specifically, the present invention relates to a communication method for wireless terminal in which a wireless channel is effectively shared by a plurality of wireless terminals so as to make a period of substantial time in communication longer.

2. Description of the Related Art

In recent years, as more and more people start to use mobile information terminals, a variety of wireless communication means for mobile information terminal have been introduced to the market. Also, at the same time, as the Internet becomes popular among people, a service for connecting a wireless terminal to the Internet has started to be provided. Specifically, the service allows a mobile information terminal with a wireless communication function (which will be referred to hereinafter as a wireless terminal) to be connected to the Internet by the use of the wireless communication means. As an example, NTT DoCoMo has a communication service called “i-mode” in which a cellular phone is used as a wireless terminal.

The internet connection type of the “i-mode” is categorized as a gateway type. The “i-mode” is disclosed in Japanese Unexamined Patent Publication No. Hei11-507152 as a WAP (type of Wireless Application Protocol) gateway based system. According to this conventional art, a wireless terminal secures a communication channel by acquiring a wireless connection link. An IP based internet connection is executed by a gateway.

The conventional method, however, does not allow a terminal over the Internet or an internet terminal to specify a wireless terminal or a mobile terminal based on the IP (Internet Protocol) address.

Another conventional art, which is generally known as Mobile IP, is disclosed in Japanese unexamined patent publication No. Hei4-227149. By having an IP packet forward function, a wireless terminal is allocated a fixed IP address, which allows the wireless terminal to be specified based on the IP address, no matter where the wireless terminal is.

However, this method results in a large traffic cost to be used for forwarding an IP packet. Japanese unexamined patent publication No. Hei 7-170286 discloses a technique for minimizing the occurrence of forwarding an IP packet while a wireless terminal is moving.

Japanese unexamined patent publication No. Hei8-213990 discloses an example of accessing a shared wireless channel effectively by a plurality of terminals. FIG. 28(A) to FIG. 28(D) show diagrams illustrating the configuration and operations of this conventional art. The following is a brief summary of this conventional method. Upon reception of a request for a transmission channel from a wireless terminal, a control station 1 transmits a transmission prohibition signal to other wireless terminals notifying that the channel is occupied. The control station 1, otherwise, transmits a channel available signal to other wireless terminals. Upon reception of those signals, wireless terminals communicate with the control station 1 only when the channel is available. If upward packets transmitted concurrently from two or more wireless terminals collided, the control station 1 transmits a collision solving signal to one of those wireless terminals. Then, the wireless terminal, when receiving the collision solving signal, sends the same packet again. The conventional art also discloses a method for solving the collision of two or more reservation signals for transmission.

An MAC operation which is generally known as ESMA/CA will be explained below with reference to FIG. 29(A) and FIG. 29(B).

FIG. 29(A) shows a timing chart illustrating a data transmission on a channel which is accessed by three nodes including the two nodes of a transmission node and a reception node trying to exchange data and the other node trying to transmitting data at the same time on the same channel. The transmission node transmits a RTS (Request to Send) message prior to the transmission of data (1101). According to this timing chart, both the reception node and the other node receive the RTS message. Then, the reception node transmits a CTS (Clear to Send) message (1102) and the other node enters into an access prohibition period (1106) during which the other node tries not to transmit data on the same channel. Provided that the other node fails to detect the RTS message transmitted from the transmission node on the channel, the other node may detect the CTS message transmitted on the channel from the reception node. In this case, the other node also enters into the access prohibition period. Even in the case of the other node detecting neither of the RTS message nor the CTS message on the channel, a data transmission by the other node would not affect the communication at least between the transmission node and the reception node in any case. Then, the transmission node transmits data (1103) and the reception node receives the data. The other node may also receive the same data if the node desires so. The reception node transmits an acknowledge message of the data (1104). The other node monitors the transmission of the acknowledge message on the channel and cancels the access prohibition period. On the contrary, in the case that the other node is allowed to monitor the data transmission only of the transmission node, the other node cancels the access prohibition period at the termination of the data transmission by the transmission node. The other node further tries not to transmit data during a back-off period (1107) which is set at random on the channel. Then, after the back-off period, the other node starts to transmit data desired (1105).

FIG. 29(B) illustrates the signal format of the RST message, the signal format of the CTS message and the signal format of the ACK message mentioned above.

As aforementioned, many number of conventional arts have been proposed for connecting a wireless terminal to a terminal over the Internet. The present invention is to provide an internet connection means for a wireless terminal which achieves a seamless communication and a high communication efficiency. Specific problems to be solved by the present invention are described below in the concrete.

A first problem to be solved by the present invention relates to the allocation of an IP address to a wireless terminal. For example, Mobile IP is a method for allocating a fixed IP address to a wireless terminal. This Mobile IP, however, requires an extra communication traffic for registering the location of a wireless terminal and/or for transferring an IP packet to a wireless terminal. Basically, this extra communication traffic is not required for a stationary terminal. In addition to that, extra cost required for preparing an IP packet in a capsule to be transmitted cannot be overlooked, either.

It is an object of the present invention, therefore, to set an effective packet route which is necessary and sufficient in convenience so that such extra communication traffic is not needed.

A second problem to be solved by the present invention relates to an improvement in communication latency in a wireless communication facility. In most cases, the wireless communication is performed in a digital mobile telephone network such as GSM (Global System for Mobile Communication) network or CDMA (Code Division Multiple Access) network. For that reason, data communication can start by securing a communication channel available in a cell or a communication zone. Such a practice, however, increases the latency before starting a communication. Furthermore, this method involves the occupation of a communication channel, and therefore may easily cause an ineffective use in a packet communication channel. Besides that, in the case that protocol conversion is needed like WAP (wireless access protocol), then extra cost is required for packet conversion.

It is a second object of the present invention, therefore, to provide a wireless communication facility which has an improved communication latency and a high efficiency in packet data transmission in order to solve that problem.

A third problem to be solved by the present invention relates to a continuous communication by a wireless terminal.

It is a third object of the present invention, therefore, to provide a wireless communication facility which can maintain an IP packet communication by a wireless terminal on the move.

A fourth problem to be solved by the present invention relates to the availability of a real time application such as a voice communication.

It is a fourth object of the present invention, therefore, to provide the availability of a real time application.

According to the conventional method of using a channel, a collision of data may lower the utilization of the channel. The conventional method poses a problem of shorten a period of essential time in communication for each wireless terminal. The collision may occur because the other wireless terminals are guaranteed to perform the same procedures.

It is a fifth object of the present invention, therefore, to provide an effective use of a channel by eliminating such collision.

### SUMMARY OF THE INVENTION

Embodiments of the present invention is directed to solving the above identified problems.

These and other objects of the embodiments of the present invention are accomplished by the present invention as hereinafter described in further detail.

According to one aspect of the present invention, an IP (Internet Protocol) communication system for wireless terminal controlled by a control center, in which a wireless terminal communicates with an internet terminal over the Internet, includes a database for storing a plurality of IP addresses. The control center may allocate one of the plurality of IP addresses to the wireless terminal for communication in response to an inquiry about the IP address of the wireless terminal. The control center may transmit a failure message to the internet terminal in response to the inquiry about the IP address of the wireless terminal if failing to detect the wireless terminal.

According to another aspect of the present invention, an IP (Internet Protocol) communication system for wireless terminal controlled by a control center, in which a wireless terminal communicates with an internet terminal using an IP address, includes a database for storing a plurality of IP addresses. The control center may allocate one of the plurality of IP addresses to the wireless terminal in response to a request from the wireless terminal for communicating with the another wireless terminal as the internet terminal.

According to another aspect of the present invention, an IP (Internet Protocol) communication method for wireless terminal controlled by a control center, in which a wireless terminal communicates with an internet terminal over the Internet, includes a step of storing a plurality of IP addresses in a database, a step of detecting an inquiry about an IP address of the wireless terminal for communication between the internet terminal and the wireless terminal, a step of allocating one of the plurality of IP addresses to the wireless terminal for communication, and a step of transmitting a failure message to the internet terminal in response to the inquiry about the IP address of the wireless terminal if failing to detect the wireless terminal.

According to another aspect of the present invention, a communication method for wireless terminal, in which a wireless terminal communicates with a plurality of wireless terminals, includes a step of transmitting a request for a broadcast communication on a channel, a step of receiving a ready message from a wireless terminal in the group in response to the request, a step of starting the broadcast communication upon reception of the ready message from the wireless terminal in the group, and a step of prohibiting other wireless terminals from accessing the channel during the broadcast communication.

According to another aspect of the present invention, a communication method for wireless terminal, in which a wireless terminal makes a communication with another wireless terminal, includes a step of transmitting a request for continuing the communication on a channel for at least one given transmission period, a step of receiving an acknowledge message upon reception of the request for continuing the communication, and a step of prohibiting other wireless terminals from accessing the channel during the at least a given period.

According to another aspect of the present invention, a communication method for wireless terminal, in which a wireless terminal communicates with another wireless terminal, includes a step of transmitting a request for occupying a plurality of channels by a wireless terminal, a step of allocating the plurality of channels to the wireless terminal, and a step of using the plurality of channels allocated in the allocating step.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an overall view of an IP communication system for wireless terminal according to a first embodiment of the present invention;

FIG. 2(A) is a block diagram of the configuration of a control center according to the first embodiment;

FIG. 2(B) is a table of wireless terminal information stored in a database management section according to the first embodiment;

FIG. 3 is a flow chart illustrating an operation of the control center according to the first embodiment;

FIG. 4 is a block diagram of the configuration of a base station according to the first embodiment;

FIG. 5 is a block diagram of the configuration of a wireless terminal;

FIG. 6 is a chart illustrating a series of operations performed by the control center, the base station and the wireless terminal according to the first embodiment;

FIG. 7 is a chart illustrating a series of operations performed by the control center, the base station and the wireless terminal according to the first embodiment;

FIG. 8 is a chart illustrating a series of operations performed by the control center, the base station and the wireless terminal according to the first embodiment;

FIG. 9 is a chart illustrating a series of operations performed by the control center, the base station and the wireless terminal according to the first embodiment;

FIG. 10(A) is a flow chart illustrating an operation of the control center according to the first embodiment;

FIG. 10(B) is a flow chart illustrating an operation of the control center according to the first embodiment;

FIG. 11 is a diagram illustrating a series of operations performed by the control center, the base station and the wireless terminal according to the first embodiment;

FIG. 12 is a diagram illustrating a series of operations performed by the control center, the base station and the wireless terminal according to the first embodiment;

FIG. 13(A) is a flow chart illustrating an operation for occupying a plurality of channels by the base station according to a second embodiment of the present invention;

FIG. 13(B) is a flow chart illustrating an operation for canceling the occupation of the plurality of channels by the base station according to the second embodiment;

FIG. 14 is an overall view of a IP communication system for wireless terminal according to a third embodiment of the present invention;

FIG. 15 is a flow chart illustrating an operation for selecting a wireless terminal according to the third embodiment;

FIG. 16 is a flow chart illustrating an operation for registering the location information of a wireless terminal according to the third embodiment;

FIG. 17(A) is a diagram illustrating a type of direct communication performed between wireless terminals;

FIG. 17(B) is a diagram illustrating a type of direct communication performed between wireless terminals;

FIG. 17(C) is a diagram illustrating a type of direct communication performed between wireless terminals;

FIG. 17(D) is a diagram illustrating a type of direct communication performed between wireless terminals;

FIG. 18 is a flow chart illustrating an operation performed between a transmission node and a reception node according to a fourth embodiment of the present invention;

FIG. 19 is a flow chart illustrating an operation performed between a transmission node and a reception node according to a fourth embodiment of the present invention;

FIG. 20(A) is a timing chart illustrating the flow of signals and data on a channel according to the fourth embodiment;

FIG. 20(B) shows the modes and formats of signals according to the fourth embodiment;

FIG. 21(A) is timing chart illustrating the flow of signals and data on a channel according to the fourth embodiment;

FIG. 21(B) shows the modes and formats of signals according to the fourth embodiment;

FIG. 22 is an explanatory diagram about channels according to the fourth embodiment;

FIG. 23 is a flow chart illustrating a logic operation for selecting one or more channels by a wireless terminal according to the fourth embodiment;

FIG. 24(A) is a flow chart illustrating an operation performed by a wireless terminal for occupying a bandwidth according to the fourth embodiment;

FIG. 24(B) is a flow chart illustrating an operation performed by a wireless terminal for canceling an occupation of the bandwidth according to the fourth embodiment;

FIG. 25 is a flow chart illustration an operation performed by a wireless terminal and a control station for occupying a plurality of bandwidths according to the fourth embodiment;

FIG. 26(A) illustrates the configuration of a MAC frame according to the fourth embodiment;

FIG. 26(B) illustrates the configuration of a MAC frame according to the fourth embodiment;

FIG. 26(C) illustrates the configuration of a MAC frame according to the fourth embodiment;

FIG. 26(D) illustrates the configuration of a MAC frame according to the fourth embodiment;

FIG. 27 is a flow chart illustrating an operation for occupying a plurality of channels based on MAC;

FIG. 28(A) is a block diagram of a conventional communication system;

FIG. 28(B) is a diagram illustrating a conventional operation for occupying and arbitrating a channel;

FIG. 28(C) is a diagram illustrating a conventional operation for occupying and arbitrating a channel;

FIG. 28(D) is a diagram illustrating an operation for occupying and arbitrating a channel according to a conventional art;

FIG. 29(A) shows a timing chart illustrating a typical flow of signals, data on a channel according to the conventional art; and

FIG. 29(B) shows the modes and formats of signals according to the conventional art.

### DETAILED DESCRIPTION OF THE PREFERRED EMBODIMENTS

Reference will now be made in detail to the present preferred embodiments of the invention, examples of which are illustrated in the accompanying drawings, wherein like reference numerals indicate like elements through out the several views.

Embodiment 1.

First of all, the characteristic configuration and facility designed for solving the problems of an IP (Internet Protocol) communication system of the present invention are discussed.

1) Efficient Facility for Setting IP Communication Route (IP Address Allocation Based on MAC Address)

In a conventional IP communication network a typical example of which is the Internet, a fixed IP communication route is set for each geographically arranged stationary router or each terminal. (This conventional IP communication network will be referred to hereinafter as a fixed network.) In the case of Mobile IP, a fixed IP address is allocated to a wireless terminal regardless of the geographical location of the wireless terminal. Data is forwarded to a wireless terminal based on the allocated IP address as the wireless terminal moves. This method, however, requires an extra operation for forwarding data to the wireless terminal on the move. According to the present invention, an IP address is used only when a wireless terminal is located in the local area and only when the wireless terminal is in communication. A control center controls an IP sub-network independently and allocates an IP address stored in the IP sub-network under the control thereof to a wireless terminal located in the local area or communication zone. In other words, an IP address is not allocated to a wireless terminal in a fixed manner but allocated dynamically or temporarily to a wireless terminal only for communication. In doing so, the IP communication system for wireless terminal of this embodiment eliminates the extra operation for forwarding data to the wireless terminal outside of he sub-network.

In the concrete, the control center is provided with a database for controlling the IP addresses of the own sub-network. The database stores a correspondence between MAC (Media Access Control) addresses assigned to the wireless terminals and IP addresses allocated to wireless terminals while in communication, and attribute information about the operating status and location of each wireless terminal. One of the IP addresses stored in the database is allocated to a wireless terminal in the local area only when it is needed for communication.

2) IP Based Connection with a Wireless Terminal

An IP connection from an internet connected terminal to a wireless terminal is based on an IP address inquiry to the control center by using the MAC address of the wireless terminal. In response to the IP address inquiry, the control center allocates an IP address to the wireless terminal. If the wireless terminal is not registered, then the control center sends a connection request message based on the latest location information to the wireless terminal by using the MAC address. The wireless terminal, upon reception of the connection request message, can communicate with an internet terminal.

In the case of a wireless terminal requesting a communication with an internet terminal, the wireless terminal transmits an IP address allocation request to the control center with the MAC address assigned to the wireless terminal. When the IP address allocation request is accepted, the control center sends the IP address to the wireless terminal. Then, the wireless terminal starts the communication based on the IP address.

3) Limitation of the Size of an IP Packet to Wireless Media MTU (Maximum Transfer Unit)

The size of an IP packet is limited to the size of MTU, that is, a maximum data transfer range, which is prescribed by a local wireless network MAC. This reduces the burden which would have to be handled by MAC. As a result, the communication latency may be more improved.

4) Hand-over Facility

All the base stations share a channel for transmitting a pilot signal. The shared channel is notified to each wireless terminal. A wireless terminal regularly monitors this pilot signal transmitted from the base station to measure the signal power level. In the case of detecting the signal weaker than a predetermined value indicating the necessity of the hand-over, the wireless terminal transmits a request for re-allocating an IP address to the control center by way of the base station based on the allocated IP address and the MAC address assigned to the wireless terminal. Upon reception of the request, the control center updates the location information of the wireless terminal stored in the database, and transmits an acknowledge message to the wireless terminal. Thus, the call can be handed over without break in the communication.

5) Mutual Connection Facility for a Plurality of Control Centers

Systems under control of the control center are independent in operation and function and connected independently to the Internet. In order to perform a smooth and efficient operation for calling a wireless terminal or handling a hand-over from one switching control station to another, a mutual connection facility for a plurality of control centers is provided.

6) MAC Controlling a Plurality of Channels

The MAC allows a plurality of communications channels to be allocated at the same time. Among the plurality of communications channels, a free and available channel is selected to be used prior to others on an equal basis.

7) Stationary Wireless Terminal Connection Facility

By a stationary wireless terminal connection facility, a stationary wireless terminal is allocated a permanent or fixed IP address. Therefore the stationary wireless terminal can be connected to an internet terminal any time by using the fixed IP address.

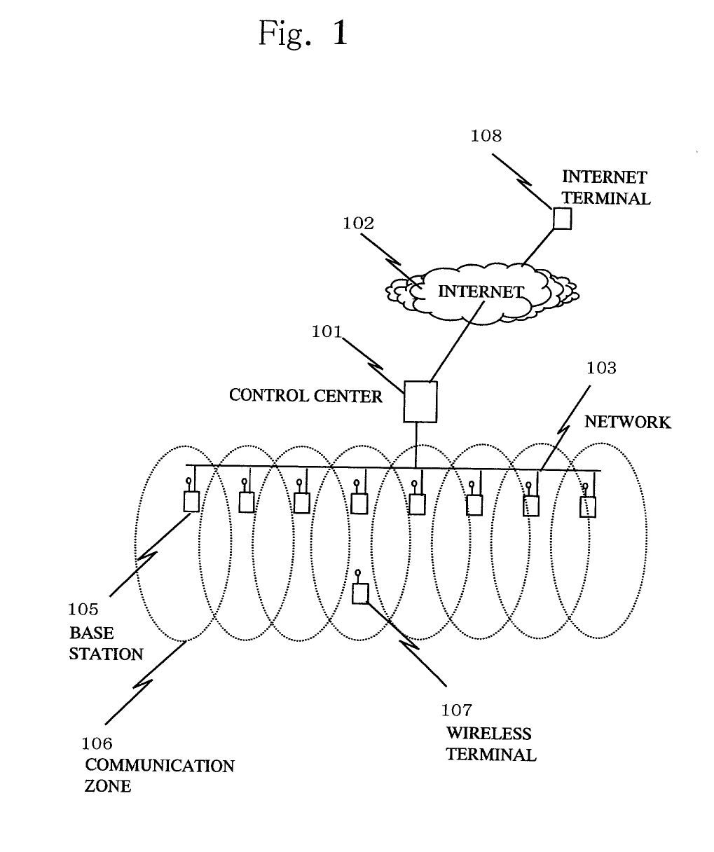

A preferred embodiment of the present invention is now discussed. FIG. 1 is an overall view of a minimum configuration of an IP communication system for wireless terminal according to the first embodiment of the present invention. A reference numeral 101 denotes a control center which is a characteristic feature of the IP communication system for wireless terminal of this embodiment. The control center 101 connects the Internet 102 with a network 103. The network 103 has a plurality of base stations 105 of the equivalent type, which are connected to one another. A reference numeral 106 denotes the communication zone of a base station 105. The communication zone 106 has at its center the base station 105 having a function of Media Access Control (which will be referred to hereinafter as MAC) on a Carrier Sense Multiple Access (which will be referred to hereinafter as CSMA) basis at a low power level, and implementing a high data transmission rate. The communication zone 106 is a small cell having approximately a 30 meter radius from the centrally located base station. The cells as the communication zones 106 are close together in the network 103 in such a manner as to overlap parts of the cells with one another. A wireless terminal 107 may enter at any time any communication zone 106 in which the wireless terminal may communicate with an internet terminal 108 by means of an IP packet.

According to this embodiment, a frequency-hopping type spread-spectrum modulation system is used for wireless communication. Forty-eight channels, each having a different hopping pattern depending on the frequency domain to be used, are employed. In each of the 48 channels, a CSMA based exclusive control is applied. The network 103 or the control center 101 controls a plurality of. A plurality of wireless terminals located in the network 103 shares a plurality of channels. In addition to that, a MAC for an exclusive control is provided for a base station and a wireless terminal. An MAC operation will be discussed later in the concrete.

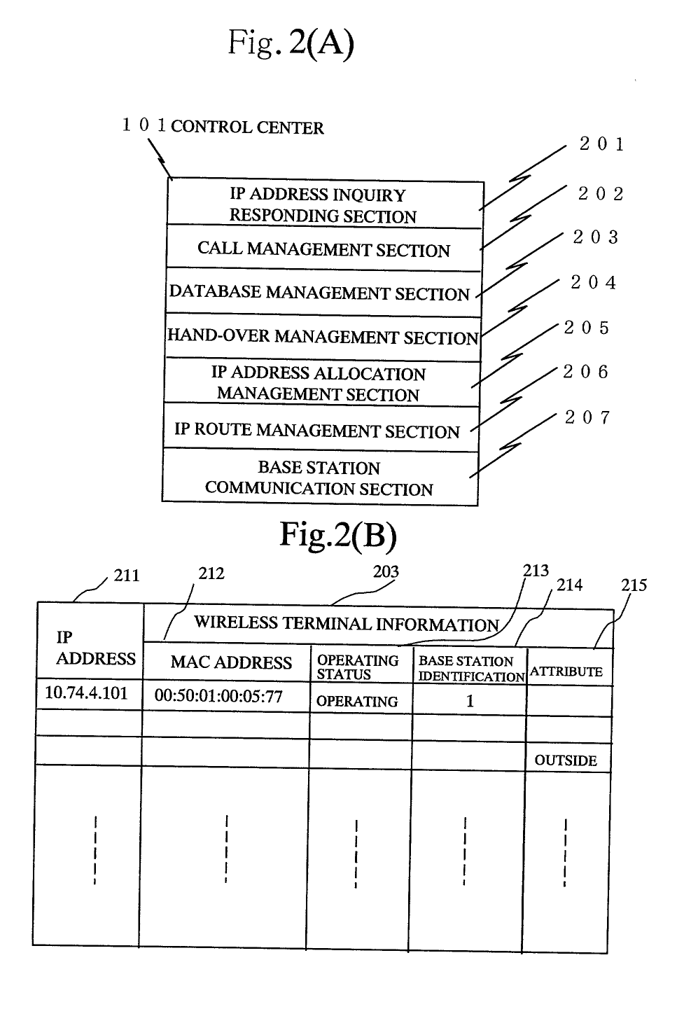

FIG. 2(A) is a block diagram illustrating the elements of the control center 101 according to this embodiment. The elements of the control center 101 are roughly divided into two functional groups: one is a group of elements having a function of dealing with a connection request from an internet terminal over the Internet or fixed network. The other is a group of elements having a function of dealing with a connection request from a wireless terminal in the network 103.

Those functions of the control center 101 are described below in detail with reference to FIG. 1, FIG. 2(A) and FIG. 2(B). The function of dealing with a connection request from an internet terminal over the fixed network is now discussed. It is assumed that the internet terminal 108 transmits an IP packet with a connection request for communicating with the wireless terminal 107 to the control center 101 by means of a MAC address assigned to the wireless terminal 107. Upon reception of the connection request, an IP address inquiry responding section 201 in the control center 101 makes an inquiry to a database management section 203 about the operating status of the wireless terminal 107. FIG. 2(B) is a table illustrating a concrete example of data stored in the database of the database management section 203 according to this embodiment. If the wireless terminal 107 is not using an IP address, then the IP address inquiry responding section 201 requests a call management section 202 to issue a call for the wireless terminal 107 by means of the MAC address to the plurality of base stations under the control of the control center 101 by way of a base station communication section 207.

In the case of responding to a call from the internet terminal 108 over the fixed network or voluntarily issuing a connection request, the wireless terminal 107 transmits a connection request through the base station 105 by means of the MAC address of its own. In other words, the wireless terminal 107 transmits an IP address allocation request to an IP address allocation management section 205 through the base station communication section 207. The IP address allocation management section 205 makes an inquiry to the database management section 203 about an IP address being available. When acquiring an IP address, the IP address management section 205 changes the status of the IP address from available to occupied. Referring to the table of FIG. 2(B), an IP address, 10.74.4.101, is allocated to the wireless terminal 107. In the case of the internet terminal 108 over the fixed network transmitting an IP packet to the wireless terminal 107 with the IP address allocated, an IP route management section 206 is requested to set an IP route so as to forward the IP packet to the right base station. The IP address allocation management section 205 issues an event to the IP address inquiry responding section 201 notifying that the IP address allocation has been completed. Then, the IP address inquiry responding section 201 sends an IP address allocated to the internet terminal over the fixed network in response to the connection request in an inquiry responding queue provided in the control center from the internet terminal 108. The hand-over management section 204 receives a hand-over request from a wireless terminal. The hand-over request is issued by a wireless terminal while in operation moving from a communication zone to a next communication zone in order to change the base station for further communication. In response to the hand-over request, the hand-over management section 204 updates data stored in the database management section 203 and the IP route management section 206 with the latest location the wireless terminal is entering.

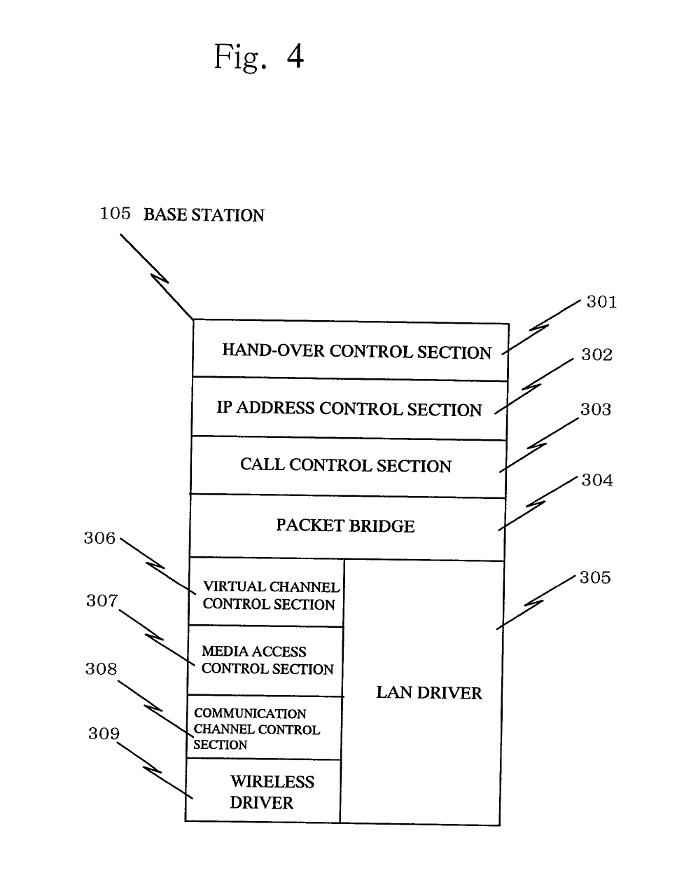

FIG. 4 shows a block diagram illustrating the elements of the base station 105 according to this embodiment. The primary functions of the base station 105 with those elements are to relay an IP packet between a wireless terminal and the control center 101, to issue a call to a wireless terminal in response to a call request sent from the control center 101, and to issue an IP based connection request to the control center 101 in response to a call from a wireless terminal.

An IP packet transmitted from the control center 101 is received by the base station 105 by way of a LAN driver 305. Then, the IP packet received is transferred through a packet bridge 304, a virtual channel control section 306, a media access control section 307, a communication channel control section 308, and a wireless driver 309 in the base station 105 and then transmitted to a wireless terminal. A call control section 303, upon reception of a call request for the IP address from the control center 101 by means of the MAC address, transmits a call message in reply by means of the MAC address by way of the virtual channel control section 306 through the wireless driver 309. A call from a wireless terminal by means of the self MAC address is received by an IP address control section 302. The IP address control section 302 issues an IP address allocation request to the control center 101 and stores a table of the association between the IP address acquired and the MAC address. A hand-over control section 301 primarily transmits a packet for transmitting the pilot signal as a tool for judging the necessity of the hand-over by a wireless terminal.

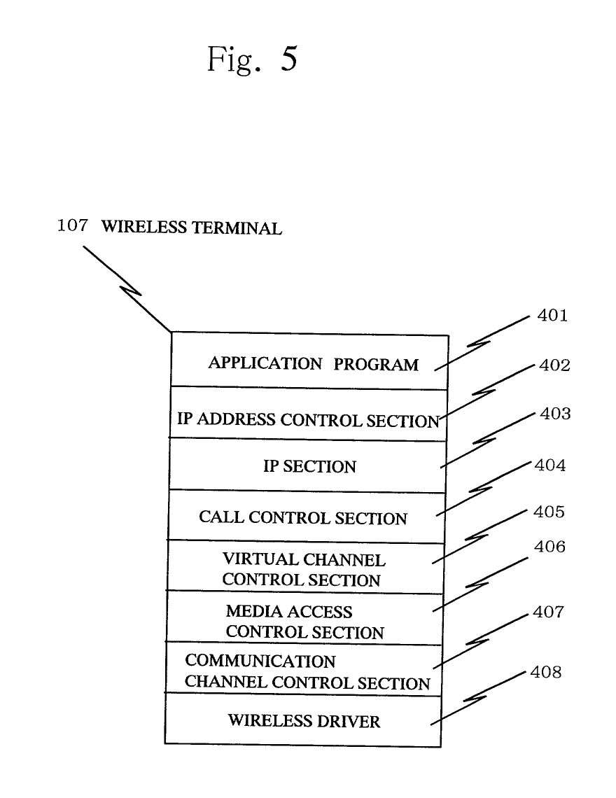

FIG. 5 shows a block diagram illustrating the elements of the wireless terminal 107 according to this embodiment. The wireless terminal 107 has an application program 401 including a telephone application, an electronic mail application, a database access application, a terminal-collaboration application for a remote telephone conference, and the like. The function of the application program 401 allows the wireless terminal 107 to communicate with an internet terminal over the Internet or with another wireless terminal 107 by using an IP address. The present invention is directed to achieving an efficient communication route over the Internet. For that reason, the wireless terminal 107 acquires a sub-network IP address from the control center of the area where the wireless terminal is located through an IP address control section 402 at the beginning of communication. When a call is issued by the base station by means of the MAC address of the wireless terminal, the call is received by a call control section 404 and notified to the application program 401. A communication packet is converted into an IP format in an IP section 403 and then transmitted by way of a virtual channel control section 405, a media access control section 406, a communication channel control section 407 and a wireless driver 408, which are the same in configuration as those of the base station 105.

That is the basic functions and configurations of the IP communication system for wireless terminal of this embodiment.

An operation of the IP communication system for wireless terminal of the first embodiment of the present invention will be discussed in respect of:

1) an IP based connection of the internet terminal 108 with the wireless terminal 107 based on a connection request issued by the internet terminal 108,

2) an IP based connection of the wireless terminal 107 with the internet terminal 108 based on a connection request issued by the wireless terminal 107, and

3) a hand-over requested by the wireless terminal 107.

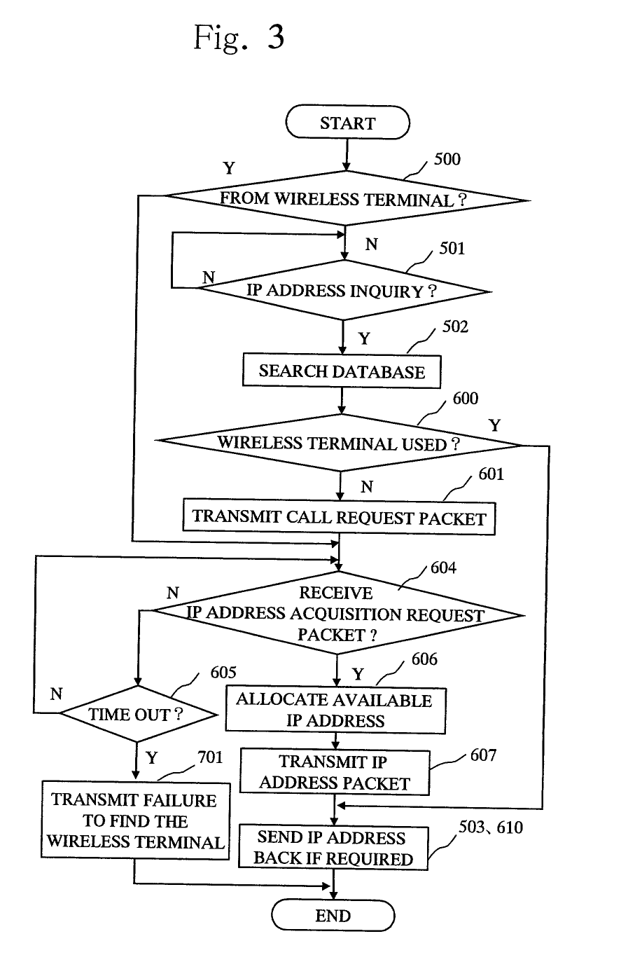

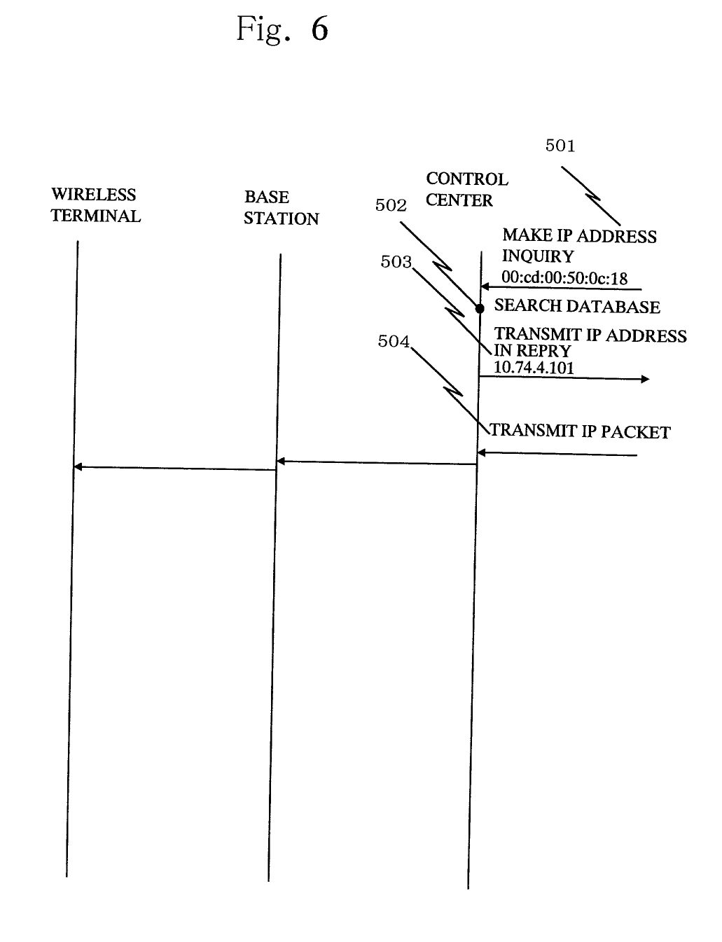

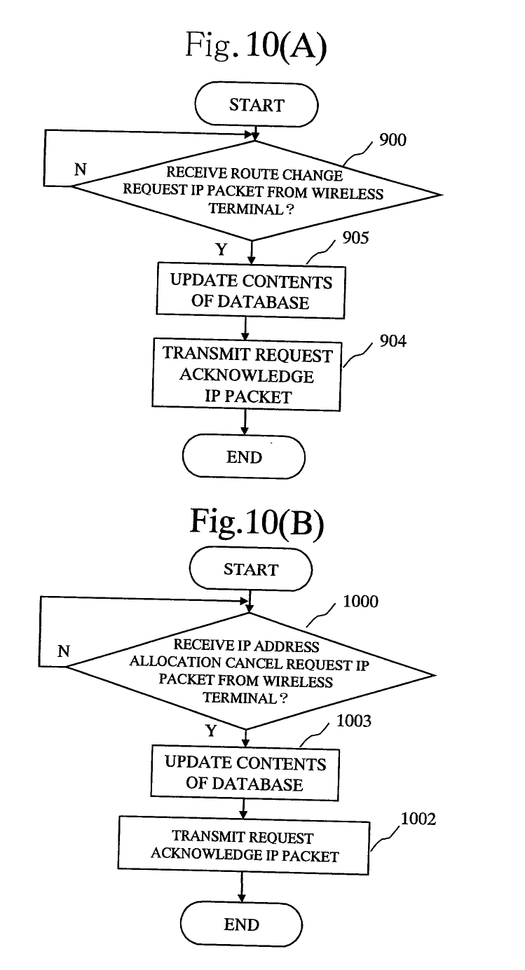

The respective operations are discussed in the order with reference to FIGS. 3, 6 to 12. FIG. 3, FIG. 10(A) and FIG. 10(B) are flow charts illustrating the operational flows of the control center 101 according to the present invention. FIGS. 6 to 9, 11 and 12 are charts illustrating a series of operations performed between the control center 101 and the wireless terminal 107.

1) An operation of IP based connection of the internet terminal 108 with the wireless terminal 107 in response to a connection request issued by the internet terminal 108 is now discussed with reference to the figures. The wireless terminal 107, the base station 105, and the control center 101 are involved in this operation. FIG. 6 is a chart illustrating a series of operations performed between the internet terminal 108 and the control center 101 for connecting the internet terminal 108 with the wireless terminal 107 in the case that the wireless terminal 107 is available for IP connection. The internet terminal 108 makes an IP address inquiry to the control center 101 about the wireless terminal 107 to be connected to the internet terminal by means of the MAC address of the wireless terminal (step 501 of FIG. 3 or of FIG. 6). Upon reception of the IP address inquiry, the control center 101 searches the self database storing IP addresses registered for the IP address inquired by means of a 48-bit MAC address of the wireless terminal, which is represented by 00:cd:00:50:0c:18 in the table of FIG. 2(B)(step 502).

As a retrieval result, obtaining an IP address registered and the operating status of the wireless terminal that the wireless terminal is operating, the control center 101 sends the IP address acquired to the internet terminal 108 in reply to the IP address inquiry (step 503). Upon reception of the IP address acquired, the internet terminal 108 is allowed to transmit an IP packet to the wireless terminal 107 desired (step 504).

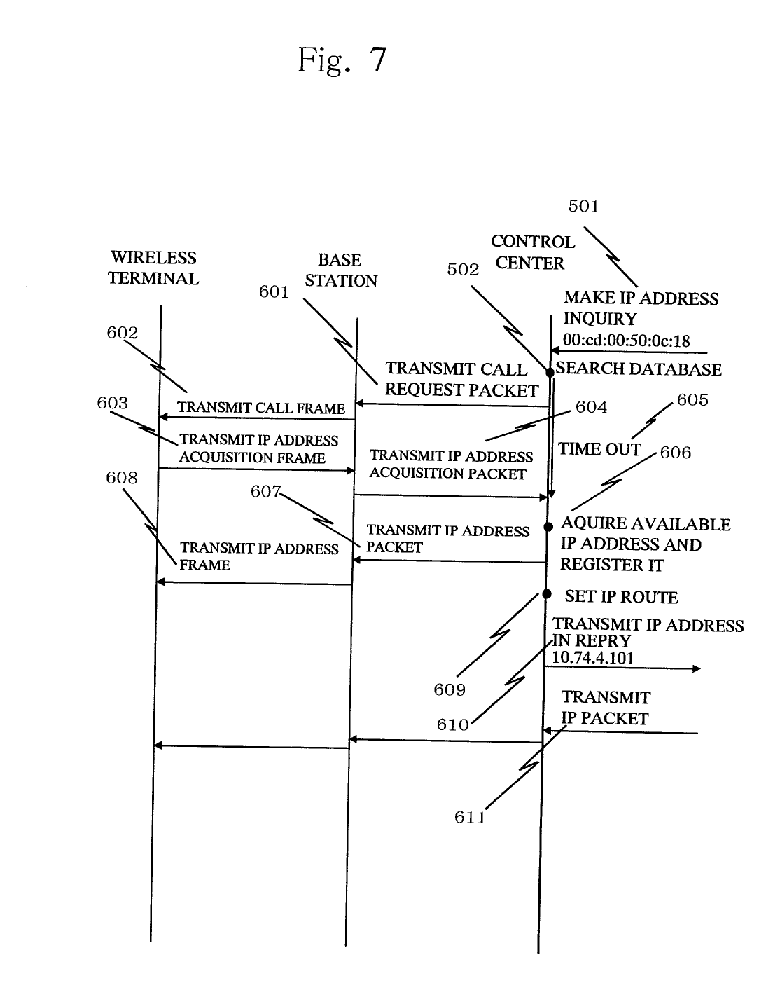

FIG. 7 is a chart illustrating a series of operations for issuing a call to the wireless terminal 107 in response to the IP address inquiry and connecting the internet terminal 108 with the wireless terminal 107 according to this embodiment.

As a result of searching the database storing IP addresses registered, finding that the IP address corresponding to the MAC address is not registered in the database, the control center 101 requests the plurality of base stations under the control of the control center 101 to issue a call by means of the MAC address of the wireless terminal requested (step 601 of FIG. 3 or of FIG. 7).

Upon reception of the call request by the control center 101, the base station 105 in the network 103 transmits a call frame by means of the MAC address of the wireless terminal (step 602). An operation for transmitting a call frame will be discussed in detail in the second embodiment of the present invention. When the wireless terminal 107 with the MAC address assigned receives a call frame, and the application program of the wireless terminal approves the call frame, the wireless terminal 107 issues an IP address acquisition frame (step 603). Upon reception of the IP address acquisition frame from the wireless terminal 107, the base station 105 transmits an IP packet for requesting the acquisition of an IP address or IP address acquisition packet to the control center 101 by means of the MAC address (step 604).

The control center 101, upon reception of the IP address acquisition packet cancels a time-out process which is set in the database search step 502, searches the database storing IP addresses registered and acquires an IP address available, and registers the acquired IP address as occupied (step 606). The control center 101 converts the acquired IP address together with the corresponding MAC address into an IP packet format and transmits the IP address packet to the base station 105 (step 607). The base station 105 transmits an IP address frame including a set of the MAC address and the IP address allocated (step 608). Upon reception of the IP address allocated, the wireless terminal 107 can transmit or receive an IP packet to or from the internet terminal 108.

The control center 101 sets a route for forwarding an IP packet to the base station 105 which relayed the IP address acquisition request from the wireless terminal 107 to the control center 101 (step 609). In addition to that, the control center 101 sends the IP address registered to internet terminal 108 in reply to the IP address inquiry (step 610). Upon reception of the IP address, the internet terminal 108 is allowed to transmit an IP packet to the wireless terminal 107 (step 611).

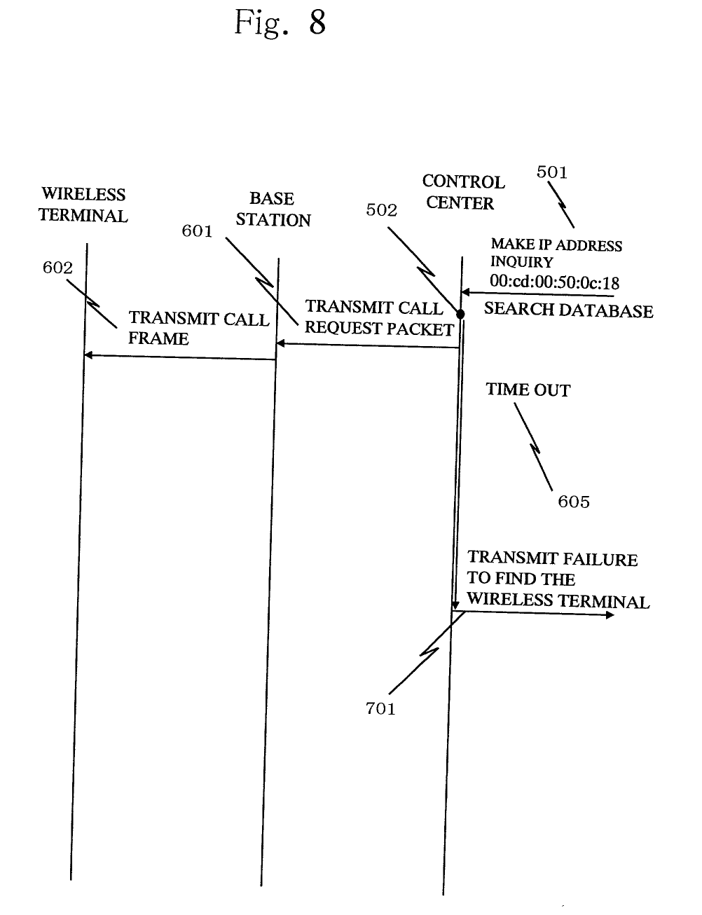

With reference to FIG. 8, an operation of the IP communication system for wireless terminal of this embodiment is now discussed in the case that no reply is received from the wireless terminal to the IP address inquiry made by the internet terminal 108 by means of the MAC address of the wireless terminal 107.

The control center 101 requests the base station under the control thereof to issue a call in the case that an IP address corresponding to the MAC address used in the IP address inquiry is not registered in the database. During a time-out period (e.g., ten seconds) set at the time of requesting the issuance of the call, the wireless terminal may not call back. In that case, the control center 101 transmits a failure message indicating that the wireless terminal is not in the network 103 under the control thereof to the internet terminal 108 transmitting the IP address inquiry (step 701). In this case, the control center 101 stores the information that the wireless terminal listed in the third line from the top in the table of FIG. 2(B) is “Outside” of the network.

2) An operation of IP based connection of the wireless terminal 107 with the internet terminal 108 in response to a connection request issued by the wireless terminal 107 is now discussed.

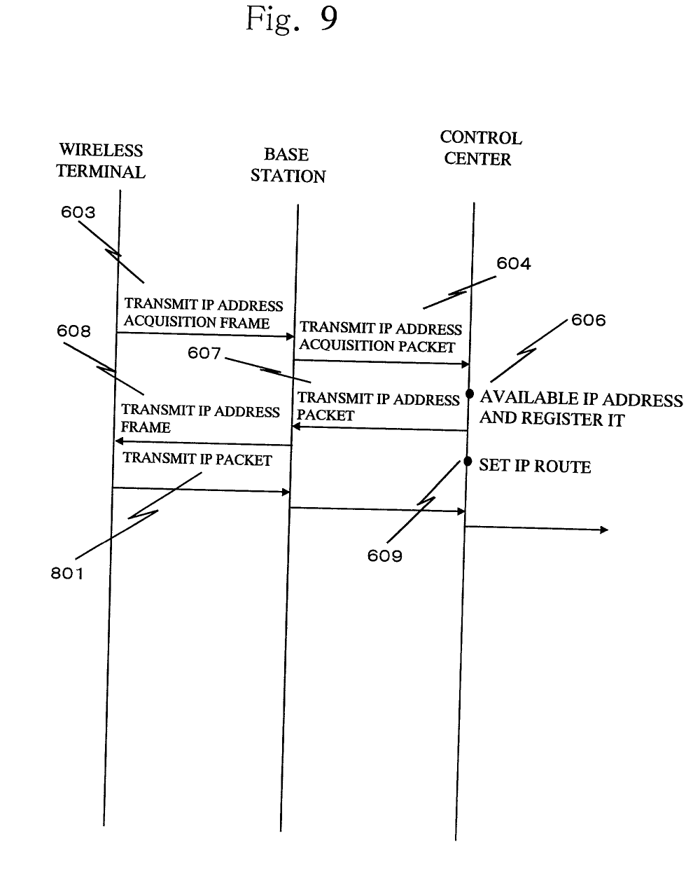

FIG. 9 is a chart illustrating a series of operations of a wireless terminal for acquiring an IP address, and transmitting an IP packet. These operations are similar to those discussed with reference to the chart of FIG. 7 for the wireless terminal responding to the call issued by the control center. When obtaining an IP address (step 608), the wireless terminal is allowed to transmit an IP packet (step 801). Similar to the case of the control center issuing a call, the IP address allocated to the wireless terminal is registered in the database management section 203 in the form shown in the table of FIG. 2(B). For that reason, the internet terminal can use the MAC address of the wireless terminal for making an IP address inquiry about the wireless terminal and transmit an IP packet to the wireless terminal. For IP, the MTU of this MAC is set as a maximum transfer data size for communication media.

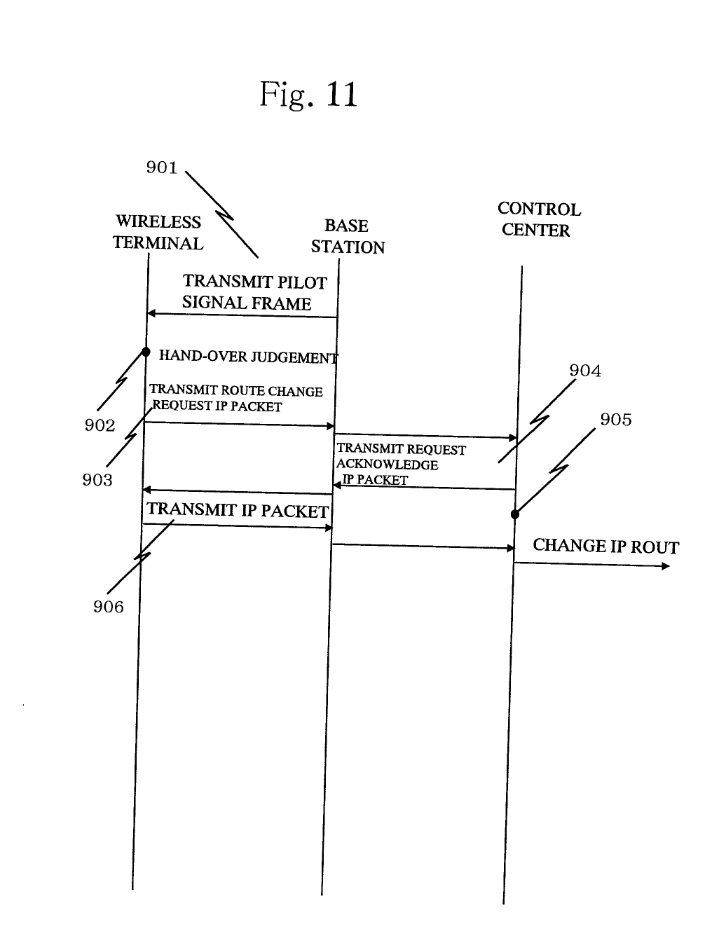

3) A wireless terminal hand-over is now discussed with referenced to FIG. 10(A) and FIG. 11.

FIG. 11 is a chart illustrating a series of hand-over operations in which the wireless terminal with an IP address allocated moves geographically and hands over the call to a communication zone under the control of the adjacent base station with the effective IP address. The base stations transmit the frames of pilot signals at regular intervals (901).

The wireless terminal detects the pilot signals and measure the strength of the signals. When the pilot signals from the base station of the communication zone the wireless terminal is located is fading and detected below a predetermined value, then the wireless terminal compares the strength of the fading pilot signal with the strength of pilot signals from the adjacent base station the wireless terminal is entering. The wireless terminal tries to hand over the call to an available channel of the adjacent base station from which a relatively stronger pilot signal is received (902 of FIG. 11). When determining that the hand-over is needed, the wireless terminal issues an route change request IP packet including a request for changing the route to the control center via the base station (903). Upon reception of the route change request IP packet, the control center 101 issues a request acknowledgment IP packet indicating that the route change request has been acknowledged to the wireless terminal (step 904 of FIG. 10(A) or FIG. 11). Then, the control center 101 changes the IP route for the wireless terminal from the current base station to the adjacent base station to the channel of which the call is to be handed over (905). After this hand-over, the wireless terminal transmits an IP packet by way of the new adjacent base station (906) and receives an IP packet from the internet terminal by way of this new base station.

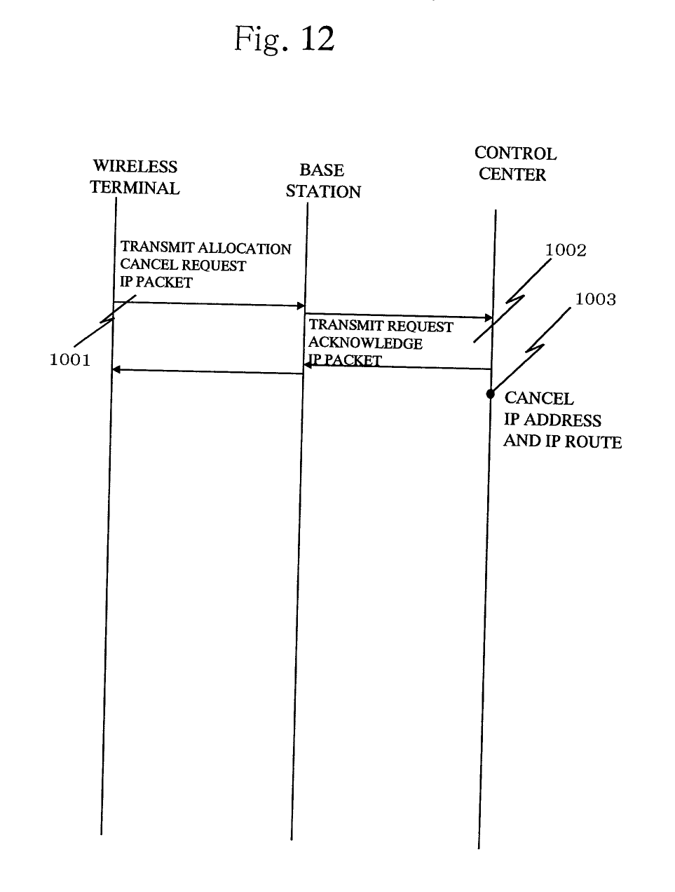

FIG. 12 shows a chart illustrating a series of operations for canceling the IP address allocated to the wireless terminal according to this embodiment. FIG. 10(B) is a flow chart illustrating those operations performed by the control center 101.

The allocation of the IP address to the wireless terminal is canceled when the application of the wireless terminal determines that the IP address is no more needed for communication. The wireless terminal transmits an allocation cancel request IP packet including a request for canceling the allocation of the IP address to the wireless terminal (1001). Upon reception of the allocation cancel request IP packet, the control center 101 transmits an request acknowledge IP packet indicating that the request for canceling the allocation of the IP address to the wireless terminal has been acknowledged(step 1002 of FIG. 10(B) or FIG. 12). Then, the control center 101 changes the status of the IP address in the IP address registration database from occupied to available and invalidates the route set for the IP address (step 1003).

Even if the allocation cancel request is not issued, the allocated IP address is invalidated by the control center 101 in the case of no IP packet transmitted from the wireless terminal for a given period of time.

As aforementioned, the IP communication system for wireless terminal of the present invention is provided with the database management section for controlling the allocation of IP addresses which are not fixed, and storing status information about a wireless terminal. An IP address is allocated to the wireless terminal in response to a request for communication over the Internet in a limited manner only when the wireless terminal is located within the network. For that reason, it is a positive effect of the IP communication system for wireless terminal of this embodiment that the extra traffic required for data transfer and the like may be eliminated.

In addition to that, the wireless terminal, when determining that the hand-over is needed, may request to change the transmission route. For that reason, it is a positive effect of the IP communication system for wireless terminal of this embodiment that a continuous communication may be achieved without break in a seamless manner when the wireless terminal on the move is entering from one communication zone to another.

Embodiment 2.

A second embodiment of the present invention introduces an inventive MAC and an inventive wireless communication facility according to the IP communication system for wireless terminal of the present invention.

The 48 channels labeled 0 to 47 are used in this embodiment, for example. Those channels are given through a spread-spectrum modulation based on a frequency-hopping method having 48 orthogonal hopping patterns in a certain frequency domain.

The MAC has two layers. A multi-channel control in the upper layer of the MAC is now discussed.

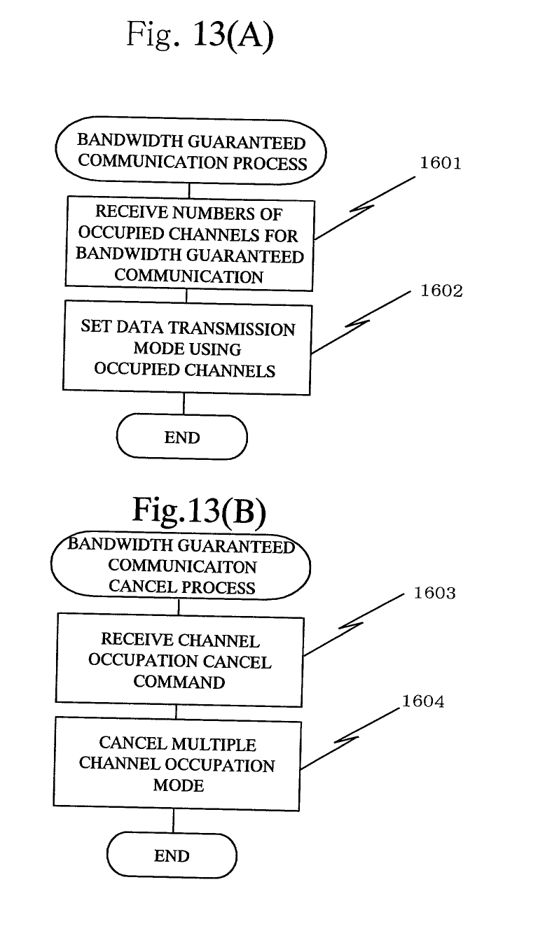

FIG. 13 is a flow chart illustrating an operation performed by the base station according to this embodiment.

Upon reception of a notification from the control center that the wireless terminal is allowed to perform a high-speed communication, the base station allows the wireless terminal to concurrently use a plurality of channels. The upper protocol will be discussed later in the next embodiment. The upper protocol of the wireless terminal allowed to use a plurality of channels outputs to the MAC an instruction to use the plurality of channels for bandwidth guaranteed communication along with the channel numbers (step 1601). Upon reception of the instruction from the upper protocol, the MAC sets the plurality of channels for bandwidth guaranteed communication so as to transmit data (step 1602). Thereafter, until the upper protocol cancels the use of the plurality of channels, data is being transmitted by the lower MAC by occupying the plurality of channels. The occupation of the plurality of channels is canceled by receiving a channel occupation cancel command from the upper protocol (1603) and then canceling the bandwidth guaranteed communication (1604).

According to this embodiment, a parallel transmission of data packets through a plurality of channels may allow an IP based burst communication (bandwidth guaranteed communication).

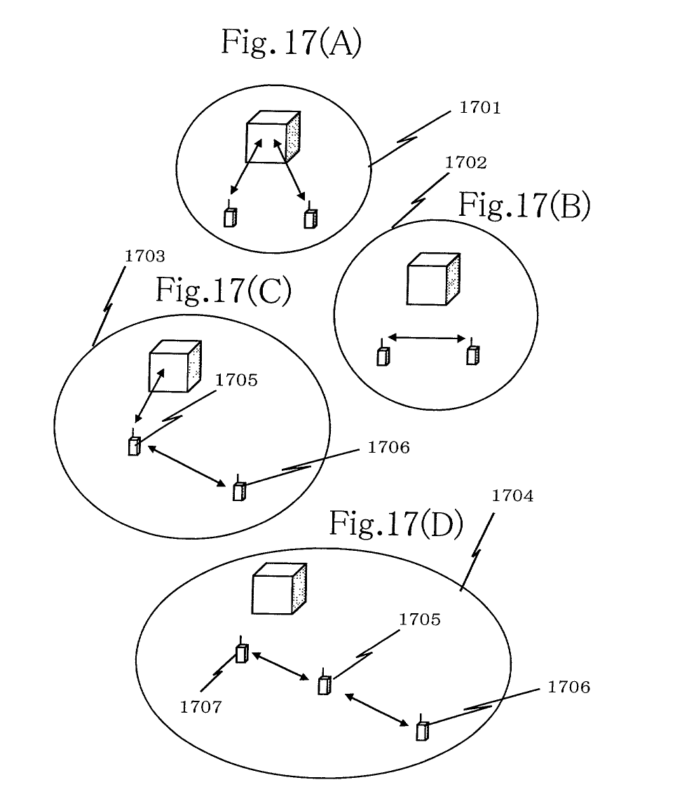

It is to be noted that the control center 101 still holds unused or available IP addresses controlled being listed in an IP address column 211 in the table of FIG. 2(B) even during a communication performed by setting an IP route as illustrated in FIG. 6, FIG. 7 or FIG. 9 of the first embodiment. By the use of the available and unused IP address thus pooled, a wireless terminal 107 may also make an IP based communication directly with another wireless terminal 107. In other words, in the IP address acquisition frame transmission 603 of FIG. 9, the destination of an IP packet may be another wireless terminal 107 instead of the internet terminal 108. With reference to FIG. 1, the wireless terminal 107 may select another wireless terminal 107 as an internet terminal instead of the internet terminal 108, and request the control center 101 to allocate an IP address. The control center 101 allocates an IP address through the same procedures discussed in the first embodiment. FIG. 17(A) indicates this condition. The control center 101, when determining that the communicating two wireless terminals are communicable directly with each other based on location information and the like, notifies the wireless terminal 107 of the enable status of the direct communication. In the case of wireless terminals being communicating in a distance of direct reach, the control center suggests the fact to the terminals and allows terminals to communicate with each other without the control center. As a result, the direct communication as illustrated in FIG. 17(B) may be achieved. It is to be noted that the direct communication includes a variation illustrated in FIG. 17(D). In the figure, two wireless terminals communicate with each other by way of another wireless terminal.

As aforementioned, it is a positive effect of the IP communication system according to this embodiment, therefore, that the high-speed communication may be achieved by occupying a plurality of channels.

Embodiment 3.

A third embodiment of the present invention introduces an IP communication system for wireless terminal in which a plurality of control centers are provided. In this embodiment, the IP based connection between an internet terminal and a wireless terminal is implemented by issuing a call to the wireless terminal by way of the plurality of control centers. An operation of the IP communication system of this embodiment is now discussed.

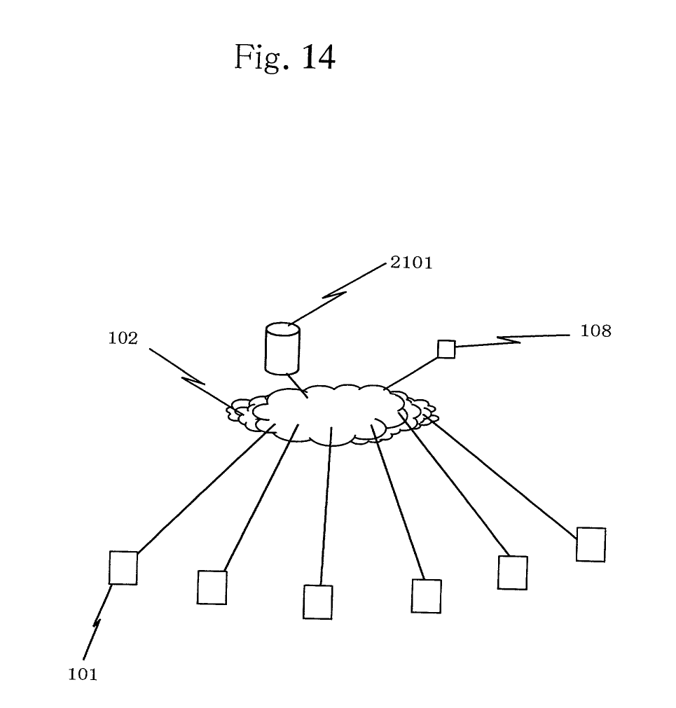

FIG. 14 shows an overall view of the IP communication system for wireless terminal according to this embodiment. Referring to the figure, the Internet 102 is connected with six control centers 101. It is to be noted that the network configuration under the control of the respective six control centers is similar to that of FIG. 1. A reference numeral 2101 denotes a terminal location database in which a last control center from which the wireless terminal obtained a current IP address is registered. The internet terminal 108 makes an IP address inquiry about the wireless terminal to the terminal location database 2101.

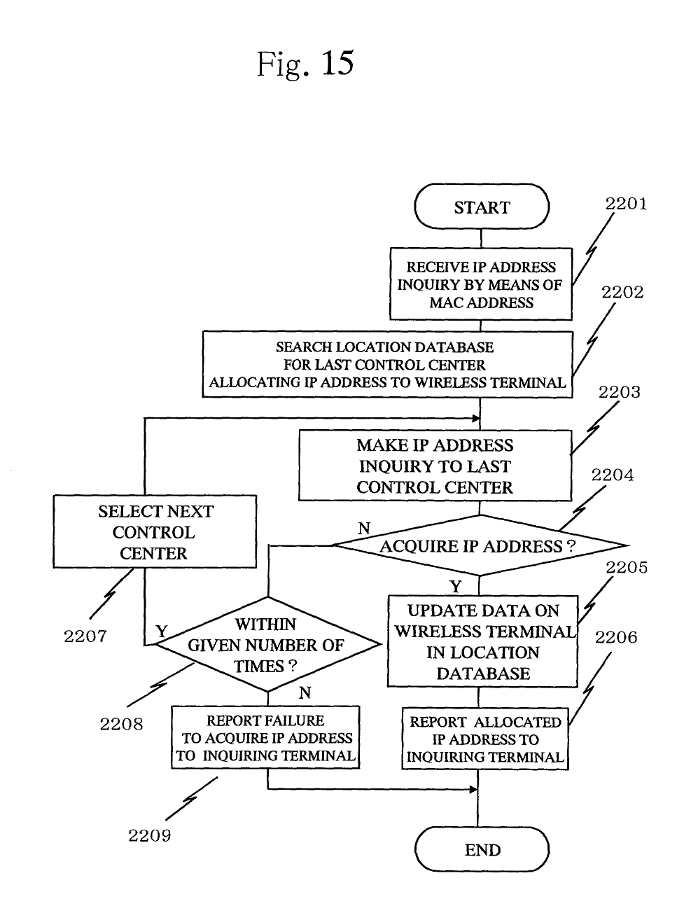

An operation of the terminal location database 2101 in response to an IP address inquiry about a wireless terminal by an internet terminal will be discussed with reference to the flow chart of FIG. 15.

Upon reception of the IP address inquiry about the wireless terminal by means of the MAC address of the wireless terminal (step 2201), the terminal location database 2101 searches the database under the control thereof. Then, the terminal location database 2101 retrieves the identification (ID) of the last control center allocating the current IP address to the wireless terminal corresponding to the MAC address (2202). The terminal location database 2101 then makes an IP address inquiry about the wireless terminal to the last control center by means of the MAC address received from the internet terminal 108 (2203). When successfully acquiring the IP address of the wireless terminal (step 2204), the terminal location database 2101 registers the ID in the database as the last control center which allocated the current IP address to the wireless terminal corresponding to the MAC address (step 2205). At the same time, the terminal location database 2101 transmits the acquired IP address of the wireless terminal to the internet terminal 108 in response to the IP address inquiry (step 2206).

In the case that the IP address inquiry results in a failure with one of the control centers (2204), the terminal location database 2101 repeats a predetermined number of times the same IP address inquiry to an adjacent control centers (step 2208). In the database, an adjacency relation between the control centers is registered as link information. The terminal location database 2101 selects a next control center on the link (step 2207), and repeats the same IP address inquiry about the wireless terminal to the next control center selected (2203). In the case of failing to acquire the IP address of the wireless terminal after repeating the predetermined number of times the IP address inquiry to adjacent control centers, the terminal location database 2101 sends an error or failure report to the internet terminal 108 in response to the IP address inquiry (step 2209). Then, the terminal location database 2101 terminates the process.

A wireless terminal knows the IP address in the terminal location database 2101 and a port number for registering the location. Therefore, the wireless terminal can register its location automatically on the move or when power is supplied.

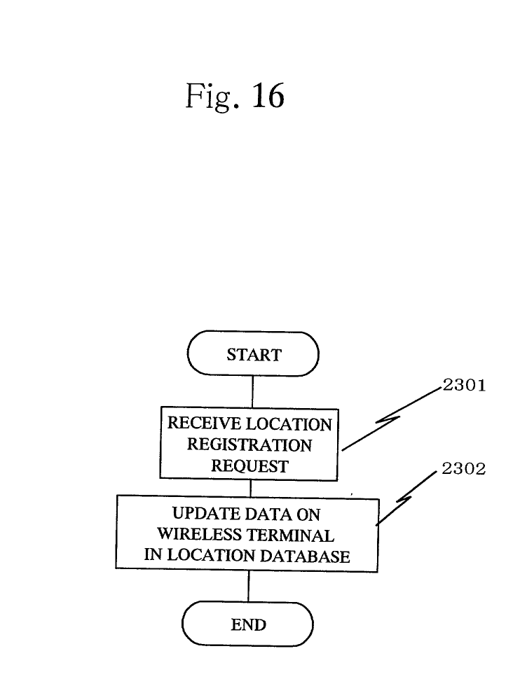

Now, an operation of the terminal location database 2101 in response to a location registration request issued by a wireless terminal will be discussed with reference to the flow chart of FIG. 16. Upon reception of a location registration request message including the ID of the control center which allocated the IP address to the wireless terminal (step 2301), the terminal location database 2101 registers the ID of the control center in the message as the last control center which allocated the current IP address to the wireless terminal.

According to this embodiment, the control center allocates a fixed IP address to a stationary terminal. In this case, the attribute 215 in the table of FIG. 2(B) is identified as “fixed connection” for the stationary terminal. With an IP address being allocated to in a fixed manner, a stationary terminal can use the same IP address any time regardless of the operating status of the terminal.

It is a positive effect of the IP communication system for wireless terminal of this embodiment provided with the aforementioned communication steps, therefore, that the extra traffic required for data transfer and the like may be eliminated.

Embodiment 4.

A fourth embodiment of the present invention introduces an inventive MAC and an inventive wireless communication facility employed in this communication system. The MAC according to the present invention is two layered including an upper exclusive control facility for controlling a plurality of channels and a lower exclusive control facility for performing an exclusive control within a channel.

The 48 channels used in this embodiment are given through a spread-spectrum modulation based on a frequency-hopping method having 48 orthogonal hopping patterns in a certain frequency domain. In the MAC and the link control, there is no security function such as encipherment. A receiver employed in this embodiment buffers two-dimensionally the data of all the hopping channels in a used frequency domain and filters the data through the 48 hopping patterns. As a result, the MAC can refer to the data of all the 48 channels.

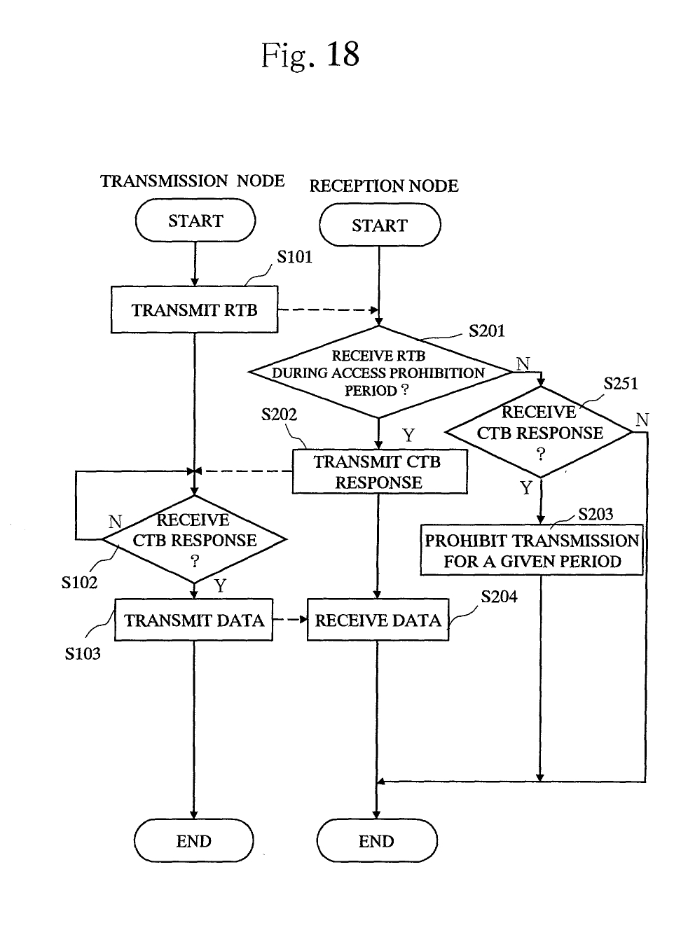

FIG. 18 is a flow chart illustrating a series of operations performed by a transmission node and a reception node of two wireless terminals according to this embodiment. The operations are now discussed with reference to the flow chart of FIG. 18.

Referring to FIG. 18, when channel 16, for example, is available and a wireless terminal wishes to start making a broadcast communication as the transmission node with a plurality of wireless terminals in a specific group, the wireless terminal transmits a RTB (Request To Broadcast) message in step S101. A wireless terminal in the group, upon reception of the RTB message, when confirmed that the RTB message is intended to be sent to the self in the group in a step S201, then transmits a CTB (Clear To Broadcast) message in response in a step S202. Upon reception of the CTB message, the wireless terminal as the transmission node transmits data at a step 103. The wireless terminal as the reception node receives the data at a step S204.

In the meantime, other wireless terminals when receiving the RTB message on channel 16 or the CTB message, prohibit themselves from accessing channel 16.

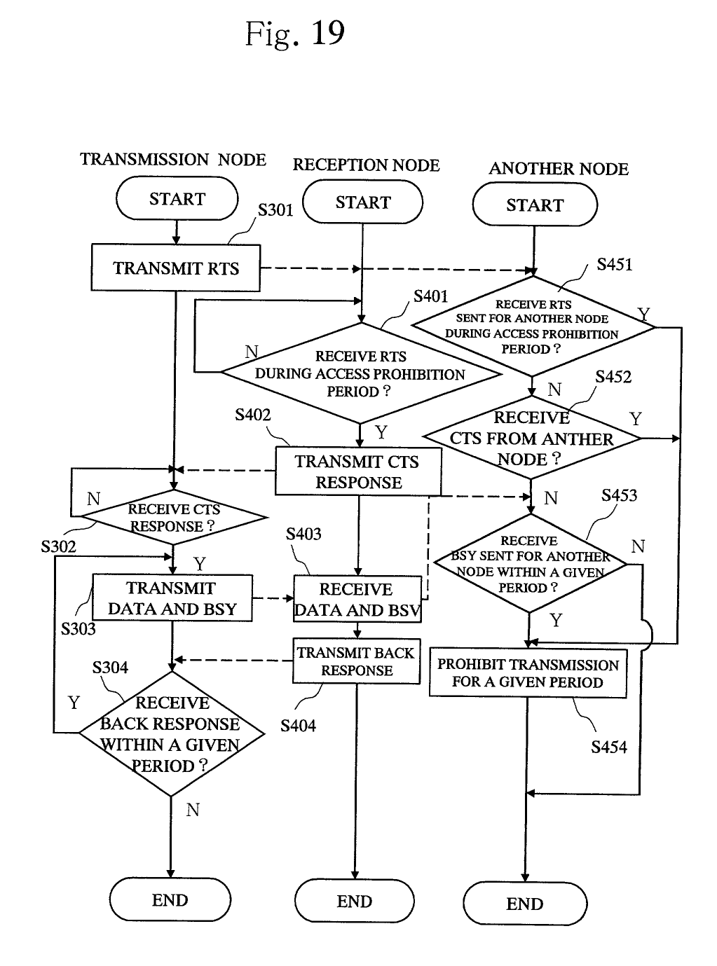

FIG. 19 is a flow chart illustrating a series of operations performed by wireless terminals as a transmission node and a reception node for occupying a channel continuously. The flow chart of FIG. 19 explains a method for using a channel for continued periods by the transmission node. If a wireless terminal wishes to transmit data continuously for more than a normal period or several transmission periods through channel 16 available, for example, the wireless terminal transmits a RTS (Request To Send, continued transmission request) message on channel 16 at a step S301. A wireless terminal, upon reception of the RTS message, when confirming that the RTS message is intended to be sent to the wireless terminal itself at a step S401, transmits a CTS (Clear To Send; acknowledgement) message in reply at a step S402. Upon reception of the CTS message, the wireless terminal as the transmission node transmits data and a BSY signal (occupation request) at a step S303. The wireless terminal as the reception node receives the data and the BSY signal at a step S403.

In the meantime, other wireless terminals, when receiving the RTS message on channel 16 transmitted to the reception node, or the CTB message on channel 16 transmitted to the transmission node, prohibit themselves from accessing channel 16.

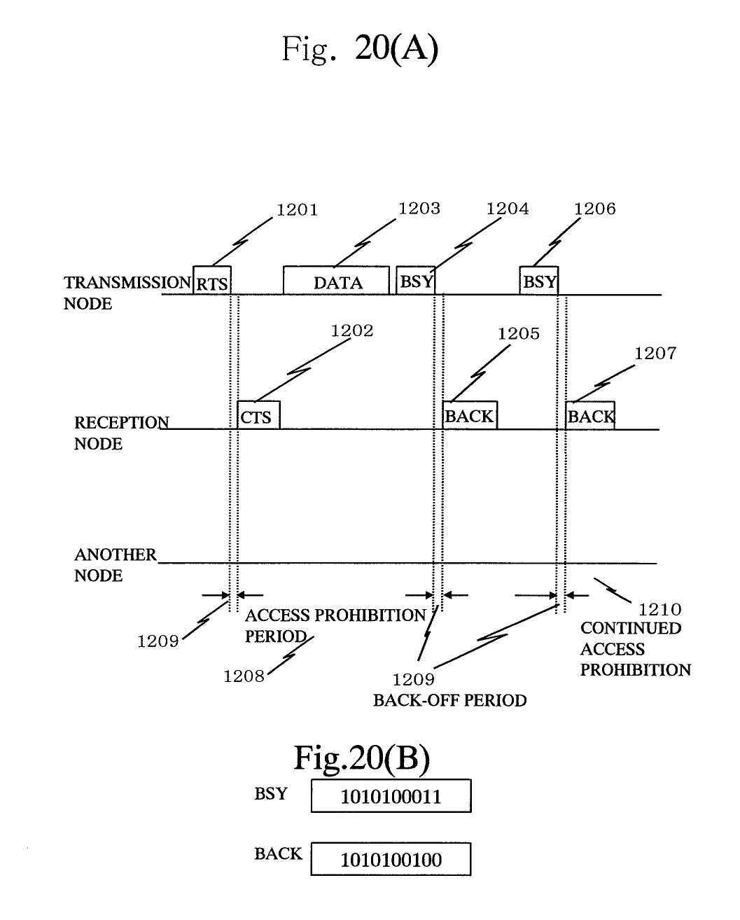

A similar operation to that discussed above will be discussed now with reference to the timing chart of FIG. 20(A). Referring to FIG. 20(A), a series of operations for transmitting the RTS message, transmitting the CTS message, and transmitting data are performed in a similar manner to those discussed with reference to FIG. 19. After transmitting data, the transmission node transmits a busy message (BSY)(1204). In response to this busy message, the reception node transmits an acknowledge message (BACK)(1205). Other wireless terminals, when monitoring the busy message or the acknowledge message on the channel, extend the access prohibition period (1208). A back off period (1209) corresponding to a broadcasting period is provided after each access prohibition period. During an access prohibition period or a back off period following the access prohibition period, when monitoring another busy message or another acknowledge message, the other wireless terminals further extend the access prohibition period (1210).

FIG. 20(B) shows a signal format of the busy (BSY) message and a signal format of the acknowledge (BACK) message according to this embodiment.

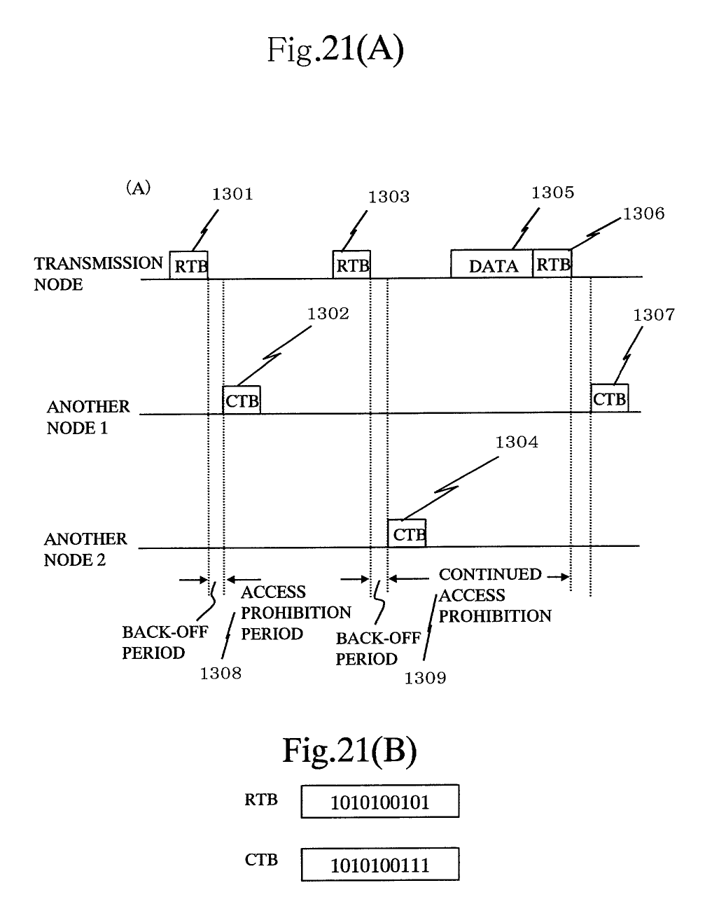

FIG. 21(A) is a timing chart illustrating an operation for transmitting broadcast data (broadcast communication) to a specific group on a channel by a wireless terminal as a transmission node without specifying any wireless terminal as the reception node. The transmission node issues a broadcast transmission request message to a plurality of wireless terminals in a specific group (1301). Another node, when finding the broadcast transmission request message, transmits a CTB message (ready response) or a permission message (1302) in response to the broadcast transmission request message. Nodes, when monitoring the broadcast transmission request message or the permission message (ready response) on the channel, including the node transmitting the broadcast transmission request message, enter into the access prohibition period for a certain period of time (1308). The transmission node, if wishing to continue the broadcast communication, transmits another broadcast transmission request message during the access prohibition period (1303).

Each node, upon reception of the broadcast transmission request message, transmits a broadcast permission message (1304) after a back off period. As a result, the access prohibition period is continued (1309). The transmission node, keeping the channel occupied, transmits data (1305). As required, the transmission node may transmit another broadcast transmission request message (1306), and any one of the other nodes in the group transmits the permission message corresponding to the broadcast transmission request (1307). When the transmission node transmits a final message among a series of the broadcast transmission request messages along with a termination signal, the channel is freed from the occupation for broadcast communication after a given period in the access prohibition period.

FIG. 21(B) shows a signal format of the RTB message and a signal format of the CTB message according to this embodiment.

That explains the exclusive control operations performed on each channel according to this embodiment.

The MAC of this embodiment controls 48 channels as a group. The upper function of the MAC operates as if it controls a single medium.

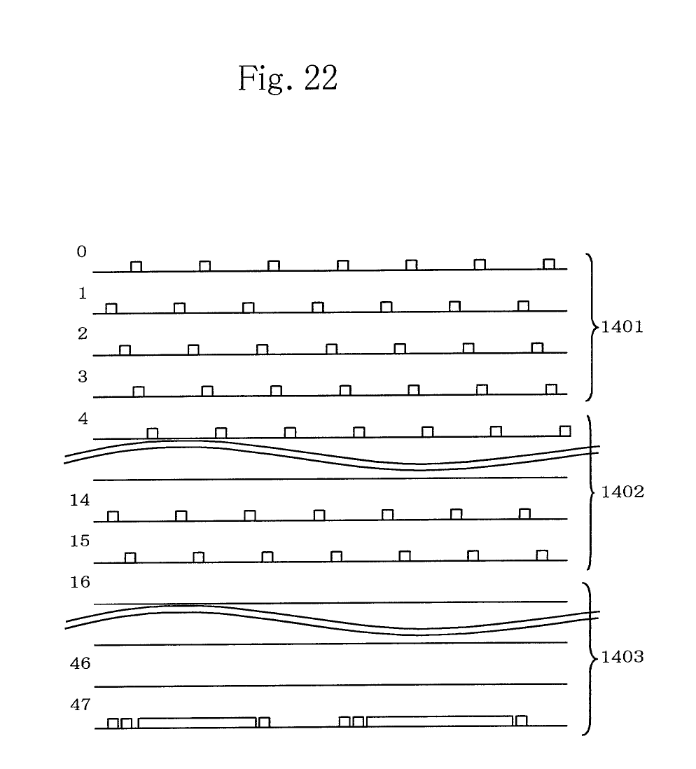

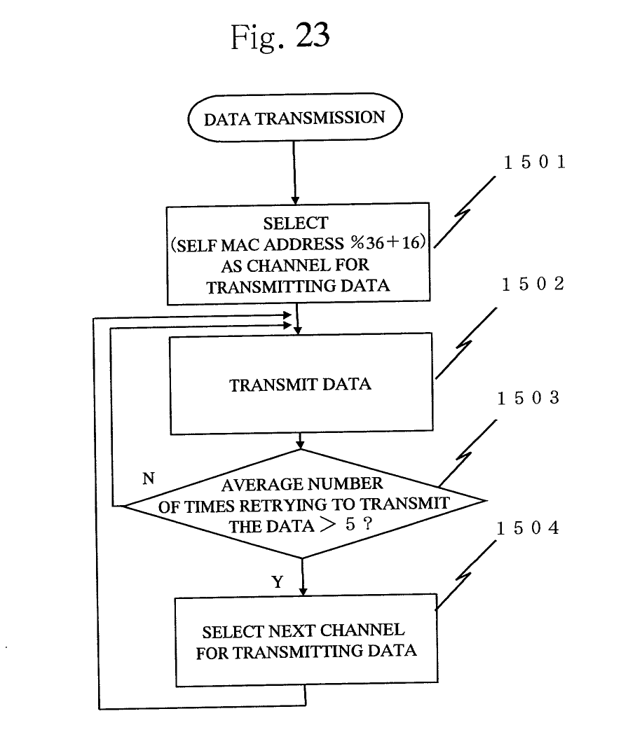

FIG. 22 is a snap shot of the 48 channels transmitting data. A multi-channel control in the upper layer of the two-layered MAC will be discussed with reference to FIG. 22 and FIG. 23.

Referring to FIG. 22, reference numerals 0 to 47 indicates channels 0 to 47 transmitting data. Channels 0 to 3 in a group 1401 are control station broadcast channels which are used as broadcast channels which are occupied regularly by one of the wireless terminals participating in the wireless communication of this embodiment which is authorized to control the use of channels. (The one of the wireless terminals will be referred to hereinafter as control station.) Channels 4 to 15 in a group 1402 are bandwidth guaranteed channels which are guaranteed for applications requiring bandwidth guaranteed communication and normally occupied by the control station to be controlled. The bandwidth quarantined channels 4 to 15 are also available for other wireless terminals as required. Channels 16 to 47 in a group 1403 are shared channels which are equally accessible by all the wireless terminals including the control station and the wireless terminals participating in the communication.

The upper layer MAC of the control station has a different logic from that of the upper layer MAC of the other wireless terminals. Operations of the shared channels 1403, the bandwidth guaranteed channels 1402 and the control station broadcast channels will be discussed in the order.

In the case of a wireless terminal using the shared channels, the MAC selects a channel to be used for data transmission in accordance with a logic illustrated in the flow chart of FIG. 23. In other words, the MAC of the wireless terminal selects a channel based on the MAC address assigned to the wireless terminal itself at the time of being initialized (1501). In the concrete, the assigned MAC address is divided by 36 and then 16 is added to the remainder to obtain the channel to be used for data transmission. If the MAX address is 00:cd:00:50:0c:18, for example, then channel 16 is used. Thereafter, a selected channel is used for data transmission (1502). While data is transmitted, the number of times the system had to wait or retry to transmit data is counted, evaluated and recorded as an accumulating total. In the case that the number of wait times is more than five in average (1503), then the next channel is selected as a data transmission channel (1504) and the next channel is to be used for future data transmissions. With a wireless terminal having a plurality of lower data transmission units, however, a plurality of channels may be used in parallel for data transmission. In the case of using a plurality of channels, the channels may be selected by adding 12, 24, 6, and 18, respectively, to an initially selected channel.

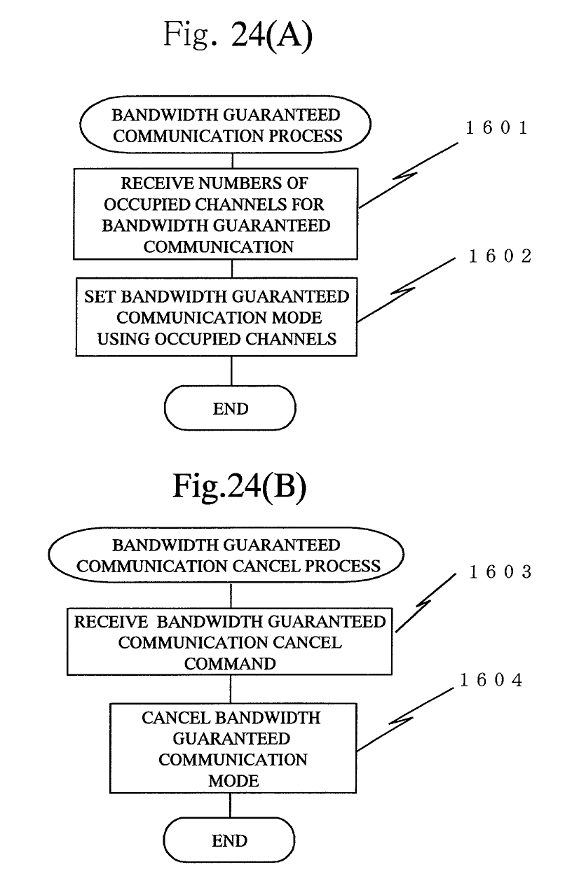

FIG. 24(A) is a flow chart illustrating an operation performed by a wireless terminal for occupying a plurality of channels for bandwidth guaranteed communication upon reception of a permission to transmit data from a control station. FIG. 24(B) is a flow chart illustrating an operation performed by a wireless terminal for canceling the occupation of the channels for bandwidth guaranteed communication in response to a cancel command from a control station. The bandwidth guaranteed channels are occupied by the control station normally when the channels are not used. The control station, when having a negotiation concluded with a wireless terminal in the upper protocol, permits the wireless terminal to use the bandwidth guaranteed channels.

Then the control station cancels the occupation of the bandwidth guaranteed channels. The upper protocol of the wireless terminal given the permission to use the bandwidth guaranteed channels issues an instruction to the MAC to use the bandwidth guaranteed channels together with the numbers of the plurality of bandwidth guaranteed channels (step 1601). Upon reception of the instruction to use the bandwidth guaranteed channels from the upper protocol of the wireless terminal, the MAC uses the specified channels for data transmission and also sets a bandwidth guaranteed communication mode for occupying the specified channels for transmission (step 1602). Thereafter, data is transmitted by the lower MAC occupying the channels until the upper protocol cancels the occupation of the bandwidth guaranteed channels. The occupation of the channels for bandwidth guaranteed communication is cancelled by the MAC when receiving a bandwidth guaranteed communication cancel command issued by the upper protocol (step 1603) and then canceling the bandwidth guaranteed communication mode (step 1604).

The control station broadcast channels are always occupied by the control station and used for transmitting a call to a wireless terminal or broadcasting, or used as downward channels corresponding to the bandwidth guaranteed channels from a wireless terminal to the control station. There is no distinction, in particular, between the lower exclusive control facility of the control station and that of a wireless terminal. The control station broadcast channels and the bandwidth guaranteed channels are controlled by the control station by means of the upper exclusive control facility.

According to the present invention, a burst communication may be achieved by transmitting data packets in parallel on a plurality of channels for an application requiring a bandwidth guaranteed communication which is designed for a telephone or the like. Operations for a bandwidth guaranteed communication performed between the control station and a wireless terminal, a bandwidth guaranteed communication performed between wireless terminals, and a burst data transmission on a plurality of channels are now discussed, respectively.

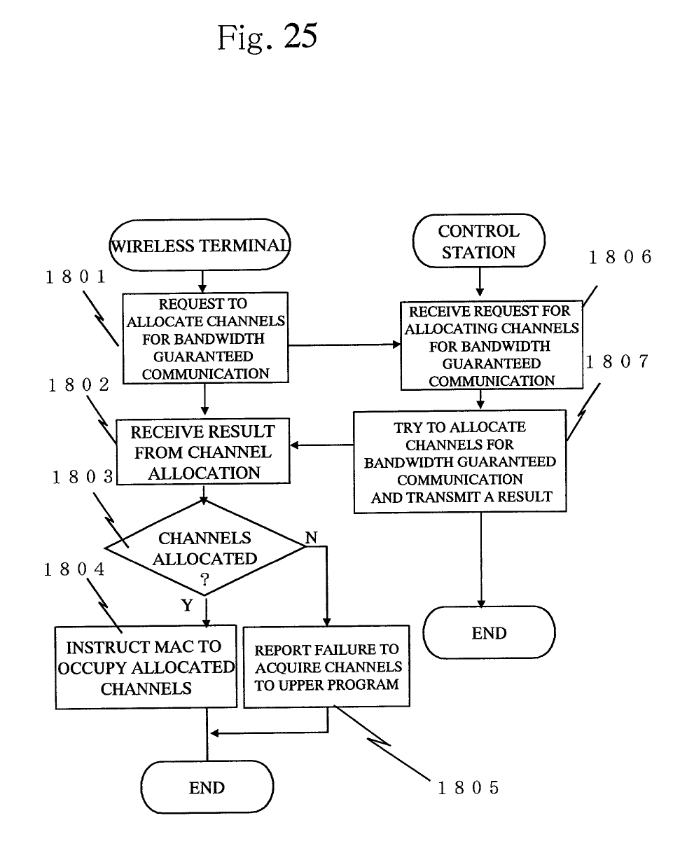

The application of a wireless terminal, when determining that the bandwidth guaranteed communication is needed, tries to obtain the bandwidth guaranteed channels in accordance with a logic illustrated by the flow chart of FIG. 25. The wireless terminal requests a port for controlling the channels of the control station to allocate the bandwidth guaranteed channels to the wireless terminal (step 1801). The control station, upon reception of the request (step 1806), examines whether the bandwidth guaranteed channels are available or not and then transmits an examined result in reply to the wireless terminal (step 1807). The wireless terminal, upon reception of the examined result (step 1802), examines whether the bandwidth guaranteed channels have been obtained successfully or not (step 1803). When the bandwidth guaranteed channels are successfully obtained, the returned message includes the numbers of allocated bandwidth guaranteed channels. In the case of successfully obtaining the bandwidth guaranteed channels, the wireless terminal instructs the MAC to use the allocated bandwidth guaranteed channels (step 1804). In the case of failing to obtain a bandwidth guaranteed channel, the wireless terminal reports an error to the upper program (step 1805) and terminates the operation. The control station allocates broadcast channels to the wireless terminal having the bandwidth guaranteed channels allocated.

In the case of wireless terminals performing the bandwidth guaranteed communication with each other, each of the wireless terminals obtains the bandwidth guaranteed channels. When the wireless terminal terminates a packet transmission by freeing the bandwidth guaranteed channels, then the bandwidth guaranteed channels are returned to be occupied by the control station.

The MAC, upon reception of a multiple channel use command, tries to use a plurality of channels for data transmission.

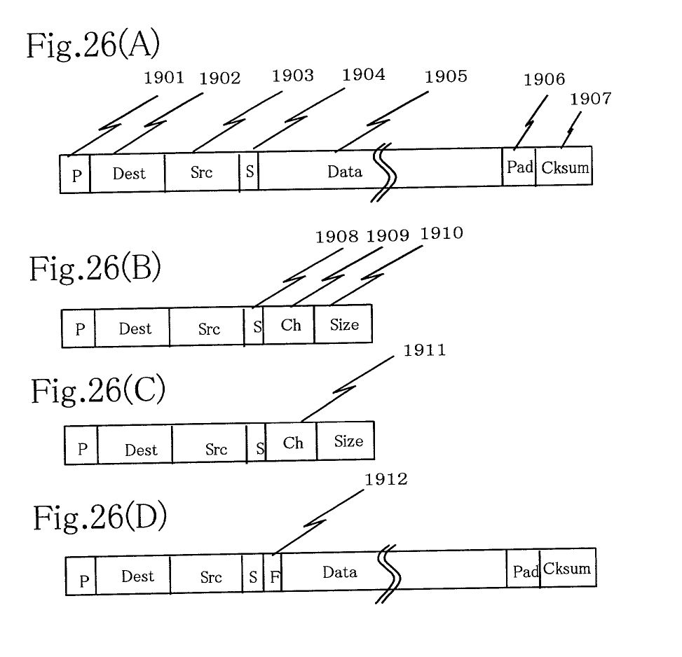

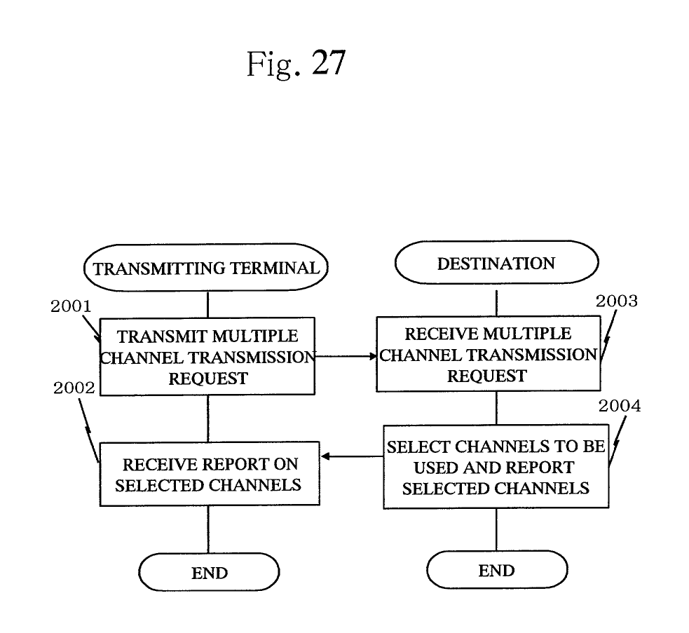

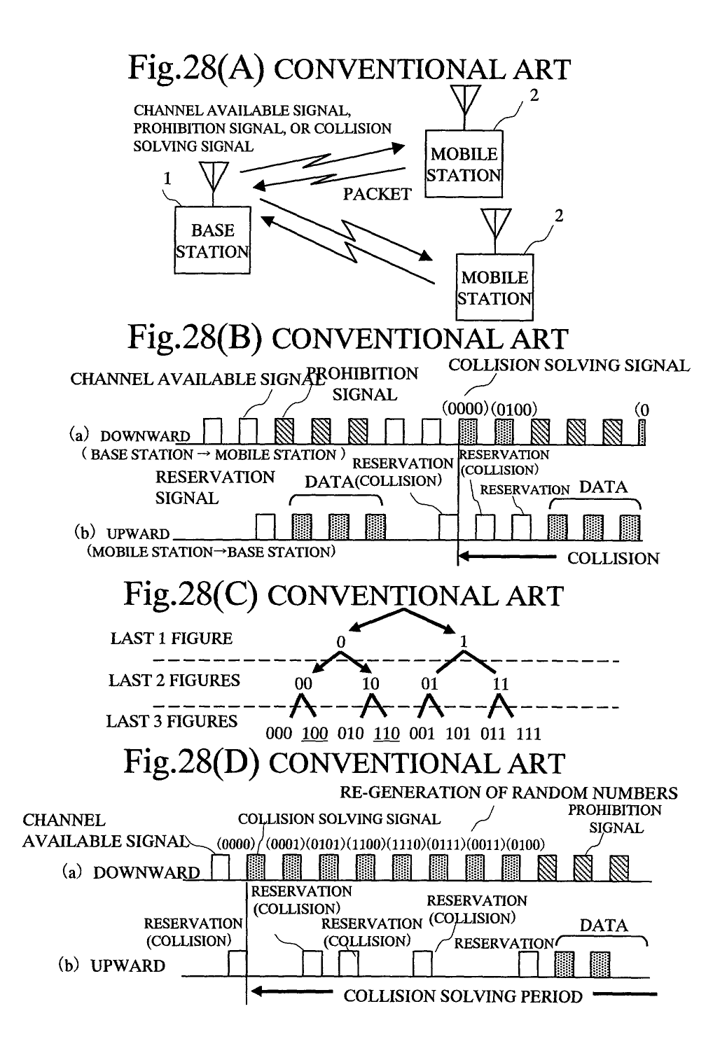

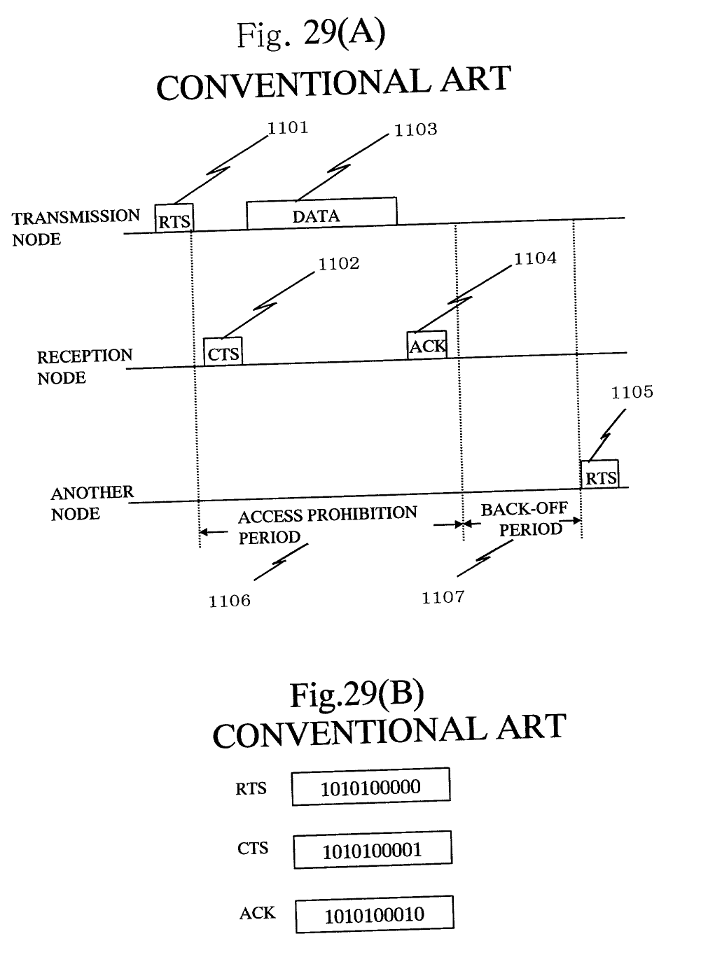

FIG. 26(A) shows the format of a normal frame of the MAC according to this embodiment. A reference numeral 1901 denotes a preamble including a delimiter. A reference numeral 1902 denotes the MAC address of a destination wireless terminal. A reference numeral 1903 denotes the MAC address of the transmitting wireless terminal as the transmitting source. A reference numeral 1904 denotes a data size. A reference numeral 1905 denotes data. A reference numeral 1906 denotes a padding character for adjusting the boundary. A reference numeral 1907 denotes check sum data for detecting an error in the frame. The MAC, upon reception of the multiple channel use command, negotiates with the MAC of the destination based on a logic illustrated in a flow chart of FIG. 27, and then transmits the data by way of the plurality of channels. The transmitting source transmits a multiple channel transmission request to the destination (step 2001). In this case, a transmission frame of FIG. 26(B) is applied.

As the data size 1904, −1, which is the complement of 2, is set. This notifies the MAC of the destination that this frame is of the multiple channel transmission request. Subsequently, a transmission channel map 1909 including a bit map composed of 32 bits is set. The number of channels are specified by the multiple channel use command. The plurality of channels is set in the order of descending priorities based on a normal channel selection theory. In addition to that, a total number of frames is calculated based on a total amount of data given by the multiple channel use command and set as a size 1910.

The MAC of the destination receives the multiple channel transmission request (step 2003). In the case of finding that the number of channels indicated in the multiple channel transmission request is beyond the reception capability of the MAC itself, the MAC of the destination cancels some of the channels in the channel bit map registration channel Ch or the transmission channel map 1909 in the frame. Thus, the MAC of the destination sets a frame 1911 of FIG. 26(C) to be transmitted to the transmitting source (step 2004). The transmitting source, upon reception of this frame, sets channels to be used for a multiple channel transmission based on the bit map returned. Thereafter, the MAC of the transmitting source transmits an amount of data specified by the upper program through a queue generated for each channel registered. FIG. 26(D) shows a frame to be used for data transmission. Data is assigned frame numbers F 1912 in the order and transmitted in parallel through the respective channels. The MAC of the destination receives the data in parallel through the registered channels, and re-arranges the received data based on the frame numbers. This is repeated until the specified number of frames are received. When the number of received frames reaches the specified number at the destination, the multiple channel transmission is canceled.

As aforementioned, according to the communication method for wireless terminal of the present invention, a collision of data on a channel shared by a plurality of wireless terminals may be reduced by the broadcast means, the continuous exclusive use of channels, or the concurrent use of a plurality of channels. This may eliminated extra time to be used for controlling traffic. It is a positive effect of the present invention, therefore, that a period of essential time in communication is made longer for each wireless terminal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An IP (Internet Protocol) communication system for wireless terminal controlled by a control center, in which a wireless terminal communicates with an internet terminal over the Internet, the IP communication system for wireless terminal comprising:
a database for storing a plurality of IP addresses;
wherein the control center allocates one of the plurality of IP addresses to the wireless terminal for communication in response to an inquiry about the IP address of the wireless terminal; and
wherein the control center transmits a failure message to the internet terminal in response to the inquiry about the IP address of the wireless terminal if failing to detect the wireless terminal.

2. The IP communication system for wireless terminal of claim 1, further comprising another base station having a communication zone;
wherein each of the base station and the another base station transmits a pilot signal for measuring strength of a signal by the wireless terminal;
wherein the wireless terminals requests the control center to perform a hand-over to the communication zone of the another base station which the wireless terminal is entering based on the pilot signal;
wherein the database further storing a location of the wireless terminal; and
wherein the control center updates the IP route to the wireless terminal, and the location of the wireless terminal stored in the database based on the hand-over.

3. The IP communication system for wireless terminal of claim 1, wherein the control center cancels the one of the IP addresses allocated to the wireless terminal either one of detecting a termination of the communication between the internet terminal and the wireless terminal and of failing to detect the wireless terminal during a period.

4. The IP communication system for wireless terminal of claim 1, wherein the control center allocates a plurality of communication channels on shared wireless medium to be used for a communication to the wireless terminal.

5. The IP communication system for wireless terminal of claim 1, further comprising:
a plurality of control centers; and
a terminal location database for registering a last one of the plurality of switching centers allocating one of the plurality of IP addresses to the wireless terminal;
wherein the terminal location database forwards the inquiry about the IP address of the wireless terminal issued by the internet terminal to the last one of the plurality of control centers; and
wherein the terminal location database forwards the inquiry about the IP address of the wireless terminal to an adjacent one of the plurality of control centers to the last one of the plurality of control centers if failing to detect the wireless terminal in the last one of the plurality of control centers.

6. An IP (Internet Protocol) communication method for wireless terminal controlled by a control center, in which a wireless terminal communicates with an internet terminal over the Internet, the IP communication method comprising:
storing a plurality of IP addresses in a database;
detecting an inquiry about an IP address of the wireless terminal for communication between the internet terminal and the wireless terminal;
allocating one of the plurality of IP addresses to the wireless terminal for communication; and
transmitting a failure message to the internet terminal in response to the inquiry about the IP address of the wireless terminal if failing to detect the wireless terminal.

7. The IP communication system for wireless terminal of claim 4, wherein the control center allocates the plurality of channels by examining a MAC frame.

8. An IP (Internet Protocol) communication system for wireless terminal controlled by a control center, in which a wireless terminal communicates with an internet terminal using an IP address, the IP communication system for wireless terminal comprising:
a database for storing a plurality of IP addresses; and
wherein the control center allocates one of the plurality of IP addresses to the wireless terminal in response to a request from the wireless terminal for communicating with the another wireless terminal as the internet terminal.

9. A communication method for wireless terminal, in which a wireless terminal communicates with a plurality of wireless terminals, the communication method for wireless terminal comprising:
transmitting a request for a broadcast communication on a channel;
receiving a ready message from a wireless terminal in the group in response to the request;
starting the broadcast communication upon reception of the ready message from the wireless terminal in the group; and
prohibiting other wireless terminals from accessing the channel during the broadcast communication.

10. A communication method for wireless terminal, in which a wireless terminal makes a communication with another wireless terminal, the communication method for wireless terminal comprising:
transmitting a request for continuing the communication on a channel for at least one given transmission period;
receiving an acknowledge message upon reception of the request for continuing the communication; and
prohibiting other wireless terminals from accessing the channel during the at least a given period.

11. A communication method for wireless terminal, in which a wireless terminal communicates with another wireless terminal, the communication method for wireless terminal comprising:
transmitting a request for occupying a plurality of channels by a wireless terminal;
allocating the plurality of channels to the wireless terminal; and
using the plurality of channels allocated in the allocating step.

12. The IP (Internet Protocol) communication method for wireless terminal of claim 6 further comprising:
having a base station to issue a pilot signal for measuring strength of a signal;
receiving a request from the wireless terminal for a hand-over of a call to a channel in a communication zone the wireless terminal is entering based on the pilot signal;
storing a location of the wireless terminal in the database based on the base station; and
updating the location of the wireless terminal stored in the database based on the hand-over.

13 The IP (Internet Protocol) communication method for wireless terminal of claim 6, further comprising:
canceling the one of the IP addresses allocated to the wireless terminal either one of detecting a termination of the communication between the internet terminal and the wireless terminal and of failing to detect the existence of the wireless terminal during a period.

14 The IP (Internet Protocol) communication method for wireless terminal of claim 6, further comprising:
allocating a plurality of channels to be used for a communication to the wireless terminal.
